(19) United States
(12) Patent Application Publication
(10) Pub. No.: US 2025/0317618 A1
(43) Pub. Date: Oct. 9, 2025

(54) METHOD AND APPARATUS FOR ENABLING BACKWARD COMPATIBLE MULTILAYER BITSTREAM IN SINGLE LAYER TRACKS

(71) Applicant: Nokia Technologies Oy, Espoo (FI)

(72) Inventors: Kashyap KAMMACHI SREEDHAR, Tampere (FI); Miska Matias HANNUKSELA, Tampere (FI); Emre Baris AKSU, Tampere (FI); Lukasz KONDRAD, Munich (DE)

(21) Appl. No.: 19/174,605

(22) Filed: Apr. 9, 2025

Related U.S. Application Data
(60) Provisional application No. 63/631,743, filed on Apr. 9, 2024.

(51) Int. Cl. H04N 21/4402; H04N 19/187; H04N 19/70; H04N 21/44

(52) U.S. Cl. CPC H04N 21/440227; H04N 19/187; H04N 19/70; H04N 21/44008

(57) ABSTRACT

Various embodiments provide methods, apparatuses, and computer program products. An example apparatus includes: at least one processor; and at least one memory storing instructions that, when executed by the at least one processor, cause the apparatus at least to perform: receiving a file; determining a single layer and a multi-layer data from the file; and extracting data and related parameters sets of the single layer and the multi-layer.

### TECHNICAL FIELD

The examples and non-limiting embodiments relate generally to multimedia transport and, more particularly to, enabling backward compatible multilayer bitstream in single layer tracks.

### BACKGROUND

It is known to provide standardized formats for encoding, signaling, or decoding of media data.

### SUMMARY

Example 1: An apparatus comprising: at least one processor; and at least one memory storing instructions that, when executed by the at least one processor, cause the apparatus at least to perform: receiving a bitstream represented by two or more layers, wherein the bitstream comprises parameter sets describing a decoder requirements; extracting a first layer from the two or more layers from the bitstream to generate an extracted at least one layer; storing the extracted first layer in a track in a file; extracting remaining layers of the two or more layers from the bitstream to generate extracted remaining layers; storing the extracted remaining layers in the track along the first layer as an auxiliary information samples associated with the first track; extracting parameters set from the bitstream to generate extracted parameters; re-writing and storing the extracted parameters in the first track; associating the extracted parameters with the first layer using a first configuration box; re-writing and storing the extracted parameters in the first track and associate the extracted parameters with the first layer using a sample group; storing the extracted parameters in the first track and associated them with the extracted remaining layers; and storing the extracted parameters in the sample group.

Example 2: The apparatus of example 1, wherein a sample entry comprises the first configuration box and a second configuration box comprises the remaining layers.

Example 3: The apparatus of example 2, wherein the apparatus is caused to perform: creating the file comprising: network abstraction layer units of a base layer with layer identity equal to 0 and NAL units of the additional layers with layer identity not equal to 0 in samples of the track; or sample auxiliary information with auxiliary information type comprising a sample entry type.

Example 4: The apparatus of example 3, wherein the apparatus is further caused to perform: defining a restricted scheme comprising a scheme type parameter in a scheme type box set equal to a 4 character code lsai.

Example 5: The apparatus of example 4, wherein when the scheme type is equal to lsai it indicates that a track comprises a multilayer bitstream and the sample entry of the track comprises the configuration box mapping to a network abstraction layer (NAL) units with a layer identity equal to 0 and a configuration box mapping to NAL units with layer identity not equal to 0.

Example 6: The apparatus of example 4, when the scheme type is equal to lsai, the track is restricted track with restricted scheme information box and encrypted with encrypted scheme information box.

Example 7: The apparatus of example 6, wherein the when the track is encrypted together with the restricted scheme, the second configuration box is moved inside the scheme information box, wherein the scheme information box resides under the restricted scheme information box or encrypted scheme information box.

Example 8: The apparatus of example 7, wherein the apparatus is further caused to perform: defining a secondary layer box or a multilayer box comprised in a sample entry of the track, wherein the secondary layer box or multilayer box indicates that the track comprises the multilayer bitstream.

Example 9: The apparatus of example 8, wherein the apparatus is further caused to perform: encapsulating the second configuration box inside the secondary layer box or the multilayer box comprised in the sample entry of the track.

Example 10: The apparatus of any of the examples 8 or 9, wherein the secondary layer box or the multilayer box comprise following parameters: auxiliary information type and auxiliary information type parameter.

Example 11: The apparatus of example 10, wherein when multiple streams are present in the track the auxiliary information type and auxiliary information type parameter map to a specific track.

Example 12: The apparatus of example 2, wherein when the sample entry of the track is a single layer sample entry and the sample entry comprises the first configuration box and the second configuration box, a profile, tier and level (PTL) structure values in a video parameter set (VPS) and a sequence parameter set (SPS) belonging to a base layer is oversaturated.

Example 13: The apparatus of claim 1, wherein NAL units related to the remaining layers are dropped by a file reader compatible with the single layer sample entry, during reconstruction of the bitstream from the track.

Example 14: The apparatus of example 1, wherein apparatus is further caused to perform: defining a high efficiency video codec sequence parameter set (HEVCSPS) sample group, wherein a sample group description entry of HVECSPS sample group comprises an HEVCSPS NAL unit with a profile, tier and level (PTL) value matched with base layer NAL units.

Example 15: The apparatus of example 14, wherein when a sample is mapped to the HEVCSPS sample group it indicates that the HEVCSPS NAL unit comprised within the sample group description entry needs to be inserted into a reconstructed AU, when a target PTL format corresponds to a PTL format indicated by the grouping type parameter field in sample to group boxes for the parameter set sample group.

Example 16: The apparatus of example 14, wherein when HSPS is comprised in a high efficiency video codec track, a sample is marked as belonging to the HSPS sample group when any of the following is true: the sample of a high efficiency video codec (HEVC) track comprises a sequence parameter set (SPS) NAL unit; or the sample references a different sample entry than a previous sample in decoding order, and the sample entry comprises the SPS NAL unit.

Example 17: The apparatus of any of the claims 14 to 16, wherein instances of the sample to a group box for the HEVCSPS sample group comprises a grouping type parameter.

Example 18: The apparatus of example 17, wherein the grouping type parameter field for the HEVC SPS parameter set sample group comprises: a HEVC PTL for a base layer; and a PTL that specifies a PTL format of a target reconstructed bitstream for which a HEVCSPS NAL unit is to be inserted.

Example 19: The apparatus of example 1, wherein the apparatus is caused to perform: defining the high efficiency video codec video parameter set (HEVCVPS) sample group, wherein, the sample group description entry of the HEVCVPS sample group comprises an HEVCVPS NAL unit with a profile, tier and level (PTL) value matched with base layer NAL units.

Example 20: The apparatus of example 19, wherein when a sample mapped to a HEVCVPS sample group it indicates that the HEVCVPS NAL unit comprised within the sample group description entry needs to be inserted into the reconstructed AU when a target PTL format corresponds to the PTL format indicated by the grouping type parameter field in the sample to group box for the HEVCVPS sample group.

Example 21: The apparatus of example 20, wherein when a sample group of type HEVCVPS sample group is comprised in a high efficiency video codec (HEVC) track, a sample is marked as belonging to the HEVCVPS sample group when any of following is true: sample of a HEVC track comprises an video parameter sequence NAL unit; or sample references a different sample entry than a previous sample in decoding order and the sample entry comprise the VPS NAL unit.

Example 22: The apparatus of any of examples 18 or 19, wherein instances of a sample to group box for the HEVCVPS sample group includes grouping type parameter.

Example 23: The apparatus of example 22, wherein the grouping type parameter field specified for the HEVCVPS sample group comprises: a HEVC PTL; and a PTL for base layer that specifies a PTL format of a target reconstructed bitstream for which a HEVCVPS NAL unit is to be inserted.

Example 24: The apparatus of example 1, wherein the apparatus is further caused to perform: defining a high efficiency video codec video parameter set and sequence parameter set HEVCVPSSPS sample group, wherein a sample group description entry of HEVCVPSSPS parameter set sample group comprises a high efficiency video (HEVC) video parameter set (VPS) network abstract layer (NAL) unit and the HEVC sequence parameter set (SPS) NAL unit with a profile, tier and level (PTL) value matched with base layer NAL units.

Example 25: The apparatus of example 24, wherein when a sample mapped to a HEVCVPSSPS parameter set sample group it indicates that the HEVC VPS NAL unit and the HEVC SPS NAL unit comprised within a sample group description entry needs to be inserted into a reconstructed AU when a target PTL format corresponds to a PTL format indicated by the grouping type parameter field in the sample to group boxes for the parameter set sample group.

Example 26: The apparatus of any of the examples 24 or 25, wherein when the HEVCVPSSPS sample group is present in a HEVC track, a sample is marked as belonging to the HEVCVPSSPS parameter set sample group when any of the following is true: a sample of a HEVC track comprises an VPS NAL unit and/or the SPS NAL unit; or sample references a different sample entry than a previous sample in decoding order and the sample entry comprises an VPS NAL unit and/or SPS NAL unit.

Example 27: The apparatus of any of the examples 24 to 26, wherein instances a sample to group box for the HEVCVPSSPS parameter set sample group comprises grouping type parameter.

Example 28: The apparatus of example 27, wherein the grouping type parameter field specified for the HEVCVPSSPS parameter set sample group comprises: an HEVC PTL; or a PTL for based that species the PTL format of a target reconstructed bitstream for which a HEVC VPS NAL unit and/or the HEVC SPS NAL unit is to be inserted.

Example 29: The apparatus of any of examples 24 to 26, wherein the apparatus is further caused to perform defining a HEVC PTL sample group, and wherein, a HEVC PTL sample group is used in the HEVC track with HEVC LHVC sample entry.

Example 30: The apparatus of example 29, wherein each sample group description entry indicates the SPS in which the PTL information is to be rewritten when the file reader drops the NAL units for the non-base layers.

Example 31: The apparatus of the example 30, wherein each sample group description entry comprises a rewriting information structure comprising: a length of profile, tier and level (PTL) syntax elements; a bit position of PTL syntax elements in a raw byte sequence payload (RBSP); a flag indicating whether to start code emulation prevention bytes are present before or within PTL; and an SPS parameter set identifier of a parameter set comprising the PTL to be rewritten.

Example 32: The apparatus of example 29, wherein each sample group description entry of the HEVC PTL sample group indicates a VPS in which the PTL information is to be rewritten when the file reader drops the NAL units for the non-base layers.

Example 33: The apparatus of the example 32, wherein each sample group description entry comprises a HEVC PTL rewriting information structure comprising: the length of PTL syntax elements; the bit position of PTL syntax elements in the containing RBSP; a flag indicating whether start code emulation prevention bytes are present before or within PTL; and/or the VPS parameter set identifier of the parameter set containing the PTL to be rewritten.

Example 34: The apparatus of example 29, wherein each sample group description entry of the HEVC PTL sample group indicates the VPS and/or SPS in which the PTL information is to be rewritten when the file reader drops the NAL units for the non-base layers.

Example 35: The apparatus of example 34, wherein, in response to base layer selection, each sample group description entry comprises a HEVC PTL rewriting information structure comprising one of more of the following: a length of PTL syntax elements; the bit position of PTL syntax elements in the containing RBSP; a flag indicating whether start code emulation prevention bytes are present before or within PTL the VPS parameter set identifier of the parameter set containing the PTL to be rewritten; and/or the SPS parameter set identifier of the parameter set containing the PTL to be rewritten.

Example 36: The apparatus of example 9, wherein a SAI corresponding a layer is stored in mdat consecutively with other SAIs of same layer and as consecutive chunks which come after the base layer chunks.

Example 37: The apparatus of example 9, wherein chunks relating to different layers are grouped together and stored in segments or track fragments.

Example 38: An apparatus comprising: at least one processor; and at least one memory storing instructions that, when executed by the at least one processor, cause the apparatus at least to perform: receiving a file; determining a single layer and a multi-layer data from the file; and extracting data and related parameters sets of the single layer and the multi-layer.

Example 39: The apparatus of example 38, wherein, when the apparatus is compatible with the single layer, the apparatus is further caused to perform: dropping network abstraction layer (NAL) units related to layers other than the single layer while reconstructing a bitstream.

Example 40: An apparatus comprising: at least one processor; and at least one memory storing instructions that, when executed by the at least one processor, cause the apparatus at least to perform: receiving a video bitstream represented by two or more layers and comprising parameter sets describing a decoder requirements; extracting a first layer from the two or more layers from the video bitstream to generate an extracted first layer; storing the extracted first layer in a first track in a file; extracting remaining layers of the two or more layers from the video bitstream to generate extracted remaining layers; storing the extracted remaining layers in the first track along the first layer as an sample auxiliary information associated with the first track; extracting parameters set from the video bitstream to generate extracted parameters of first layer; re-writing and storing the extracted parameters of first layer in the first track; associating the extracted parameters with the first layer using a first configuration box; storing the first configuration box in the sample entry of the first track; re-writing and storing the extracted parameters of remaining layers in the first track associating the extracted parameters with the remaining layer using a second configuration box; creating a restricted scheme using SchemeTypeBox with the scheme_type parameter in the SchemeTypeBox indicating the presence of remaining layers in the sample auxiliary information of the first track; creating a new SecondaryLayerSAIBox or MultiLayerSAIBox present in the SampleEntry of the first track; and storing the second configuration box in the SecondaryLayerSAIBox or MultiLayerSAIBox.

Example 41: An apparatus comprising: at least one processor; and at least one memory storing instructions that, when executed by the at least one processor, cause the apparatus at least to perform: receiving a file; determining a presence for a first layer and a remaining layers data from the file; extracting data and related parameters sets of the first layer from a first configuration box; extracting data and related parameters sets of the remaining layers from a second configuration box; wherein a restricted scheme using SchemeTypeBox is created with the scheme_type parameter in the SchemeTypeBox for indicating the presence of remaining layers; and wherein a new SecondaryLayerSAIBox or MultiLayerSAIBox present in the SampleEntry stores the second configuration box in the SecondaryLayerSAIBox or MultiLayerSAIBox.

Example 42: A method comprising: receiving a bitstream represented by two or more layers, wherein the bitstream comprises parameter sets describing a decoder requirements; extracting a first layer from the two or more layers from the bitstream to generate an extracted at least one layer; storing the extracted first layer in a track in a file; extracting remaining layers of the two or more layers from the bitstream to generate extracted remaining layers; storing the extracted remaining layers in the track along the first layer as an auxiliary information samples associated with the first track; extracting parameters set from the bitstream to generate extracted parameters; re-writing and storing the extracted parameters in the first track; associating the extracted parameters with the first layer using a first configuration box; re-writing and storing the extracted parameters in the first track and associate the extracted parameters with the first layer using a sample group; storing the extracted parameters in the first track and associated them with the extracted remaining layers; and storing the extracted parameters in the sample group.

Example 43: The method of example 42, wherein a sample entry comprises the first configuration box and a second configuration box comprises the remaining layers.

Example 44: The method of example 43 further comprising: creating the file comprising: network abstraction layer units of a base layer with layer identity equal to 0 and NAL units of the additional layers with layer identity not equal to 0 in samples of the track; or sample auxiliary information with auxiliary information type comprising a sample entry type.

Example 45: The method of example 44 further comprising: defining a restricted scheme comprising a scheme type parameter in a scheme type box set equal to a 4 character code lsai.

Example 46: The method of example 45, wherein when the scheme type is equal to lsai it indicates that a track comprises a multilayer bitstream and the sample entry of the track comprises the configuration box mapping to a network abstraction layer (NAL) units with a layer identity equal to 0 and a configuration box mapping to NAL units with layer identity not equal to 0.

Example 47: The method of example 45, when the scheme type is equal to lsai, the track is restricted track with restricted scheme information box and encrypted with encrypted scheme information box.

Example 48: The method of example 47, wherein the when the track is encrypted together with the restricted scheme, the second configuration box is moved inside the scheme information box, wherein the scheme information box resides under the restricted scheme information box or encrypted scheme information box.

Example 49: The method of example 48 further comprising: defining a secondary layer box or a multilayer box comprised in a sample entry of the track, wherein the secondary layer box or multilayer box indicates that the track comprises the multilayer bitstream.

Example 50: The method of example 49 further comprising: encapsulating the second configuration box inside the secondary layer box or the multilayer box comprised in the sample entry of the track.

Example 51: The method of any of the examples 49 or 50, wherein the secondary layer box or the multilayer box comprise following parameters: auxiliary information type and auxiliary information type parameter.

Example 52: The method of example 51, wherein when multiple streams are present in the track the auxiliary information type and auxiliary information type parameter map to a specific track.

Example 53: The method of example 43, wherein when the sample entry of the track is a single layer sample entry and the sample entry comprises the first configuration box and the second configuration box, a profile, tier and level (PTL) structure values in a video parameter set (VPS) and a sequence parameter set (SPS) belonging to a base layer is oversaturated.

Example 54: The method of example 42, wherein NAL units related to the remaining layers are dropped by a file reader compatible with the single layer sample entry, during reconstruction of the bitstream from the track.

Example 55: The method of example 42 further comprising: defining a high efficiency video codec sequence parameter set (HEVCSPS) sample group, wherein a sample group description entry of HVECSPS sample group comprises an HEVCSPS NAL unit with a profile, tier and level (PTL) value matched with base layer NAL units.

Example 56: The method of example 55, wherein when a sample is mapped to the HEVCSPS sample group it indicates that the HEVCSPS NAL unit comprised within the sample group description entry needs to be inserted into a reconstructed AU, when a target PTL format corresponds to a PTL format indicated by the grouping type parameter field in sample to group boxes for the parameter set sample group.

Example 57: The method of example 55, wherein when HSPS is comprised in a high efficiency video codec track, a sample is marked as belonging to the HSPS sample group when any of the following is true: the sample of a high efficiency video codec (HEVC) track comprises a sequence parameter set (SPS) NAL unit; or the sample references a different sample entry than a previous sample in decoding order, and the sample entry comprises the SPS NAL unit.

Example 58: The method of any of the claims 55 to 57, wherein instances of the sample to a group box for the HEVCSPS sample group comprises a grouping type parameter.

Example 59: The method of example 58, wherein the grouping type parameter field for the HEVC SPS parameter set sample group comprises: a HEVC PTL for a base layer; and a PTL that specifies a PTL format of a target reconstructed bitstream for which a HEVCSPS NAL unit is to be inserted.

Example 60: The method of example 42 further comprising: defining the high efficiency video codec video parameter set (HEVCVPS) sample group, wherein, the sample group description entry of the HEVCVPS sample group comprises an HEVCVPS NAL unit with a profile, tier and level (PTL) value matched with base layer NAL units.

Example 61: The method of example 60, wherein when a sample mapped to a HEVCVPS sample group it indicates that the HEVCVPS NAL unit comprised within the sample group description entry needs to be inserted into the reconstructed AU when a target PTL format corresponds to the PTL format indicated by the grouping type parameter field in the sample to group box for the HEVCVPS sample group.

Example 62: The method of example 61, wherein when a sample group of type HEVCVPS sample group is comprised in a high efficiency video codec (HEVC) track, a sample is marked as belonging to the HEVCVPS sample group when any of following is true: sample of a HEVC track comprises an video parameter sequence NAL unit; or sample references a different sample entry than a previous sample in decoding order and the sample entry comprise the VPS NAL unit.

Example 63: The method of any of examples 59 or 60, wherein instances of a sample to group box for the HEVCVPS sample group includes grouping type parameter.

Example 64: The method of example 63, wherein the grouping type parameter field specified for the HEVCVPS sample group comprises: a HEVC PTL; and a PTL for base layer that specifies a PTL format of a target reconstructed bitstream for which a HEVCVPS NAL unit is to be inserted.

Example 65: The method of example 42 further comprising: defining a high efficiency video codec video parameter set and sequence parameter set HEVCVPSSPS sample group, wherein a sample group description entry of HEVCVPSSPS parameter set sample group comprises a high efficiency video (HEVC) video parameter set (VPS) network abstract layer (NAL) unit and the HEVC sequence parameter set (SPS) NAL unit with a profile, tier and level (PTL) value matched with base layer NAL units.

Example 66: The method of example 65, wherein when a sample mapped to a HEVCVPSSPS parameter set sample group it indicates that the HEVC VPS NAL unit and the HEVC SPS NAL unit comprised within a sample group description entry needs to be inserted into a reconstructed AU when a target PTL format corresponds to a PTL format indicated by the grouping type parameter field in the sample to group boxes for the parameter set sample group.

Example 67: The method of any of the examples 65 or 66, wherein when the HEVCVPSSPS sample group is present in a HEVC track, a sample is marked as belonging to the HEVCVPSSPS parameter set sample group when any of the following is true: a sample of a HEVC track comprises an VPS NAL unit and/or the SPS NAL unit; or sample references a different sample entry than a previous sample in decoding order and the sample entry comprises an VPS NAL unit and/or SPS NAL unit.

Example 68: The method of any of the examples 65 to 67, wherein instances a sample to group box for the HEVCVPSSPS parameter set sample group comprises grouping type parameter.

Example 69: The method of example 68, wherein the grouping type parameter field specified for the HEVCVPSSPS parameter set sample group comprises: an HEVC PTL; or a PTL for based that species the PTL format of a target reconstructed bitstream for which a HEVC VPS NAL unit and/or the HEVC SPS NAL unit is to be inserted.

Example 70: The method of any of examples 65 to 67 further comprising defining a HEVC PTL sample group, and wherein, a HEVC PTL sample group is used in the HEVC track with HEVC LHVC sample entry.

Example 71: The method of example 70, wherein each sample group description entry indicates the SPS in which the PTL information is to be rewritten when the file reader drops the NAL units for the non-base layers.

Example 72: The method of the example 71, wherein each sample group description entry comprises a rewriting information structure comprising: a length of profile, tier and level (PTL) syntax elements; a bit position of PTL syntax elements in a raw byte sequence payload (RBSP); a flag indicating whether to start code emulation prevention bytes are present before or within PTL; and an SPS parameter set identifier of a parameter set comprising the PTL to be rewritten.

Example 73: The method of example 70, wherein each sample group description entry of the HEVC PTL sample group indicates a VPS in which the PTL information is to be rewritten when the file reader drops the NAL units for the non-base layers.

Example 74: The method of the example 73, wherein each sample group description entry comprises a HEVC PTL rewriting information structure comprising: the length of PTL syntax elements; the bit position of PTL syntax elements in the containing RBSP; a flag indicating whether start code emulation prevention bytes are present before or within PTL; and/or the VPS parameter set identifier of the parameter set containing the PTL to be rewritten.

Example 75: The method of example 70, wherein each sample group description entry of the HEVC PTL sample group indicates the VPS and/or SPS in which the PTL information is to be rewritten when the file reader drops the NAL units for the non-base layers.

Example 76: The method of example 75, wherein, in response to base layer selection, each sample group description entry comprises a HEVC PTL rewriting information structure comprising one or more of the following: a length of PTL syntax elements; the bit position of PTL syntax elements in the containing RBSP; a flag indicating whether start code emulation prevention bytes are present before or within PTL the VPS parameter set identifier of the parameter set containing the PTL to be rewritten; and/or the SPS parameter set identifier of the parameter set containing the PTL to be rewritten.

Example 77: The method of example 50, wherein a SAI corresponding a layer is stored in mdat consecutively with other SAIs of same layer and as consecutive chunks which come after the base layer chunks.

Example 78: The method of example 50, wherein chunks relating to different layers are grouped together and stored in segments or track fragments.

Example 79: A method comprising: receiving a file; determining a single layer and a multi-layer data from the file; and extracting data and related parameters sets of the single layer and the multi-layer.

Example 80: The method of example 79, wherein, when a file reader is compatible with the single layer, the method further comprises: dropping network abstraction layer (NAL) units related to layers other than the single layer while reconstructing a bitstream.

Example 81: A method comprising: receiving a video bitstream represented by two or more layers and comprising parameter sets describing a decoder requirements; extracting a first layer from the two or more layers from the video bitstream to generate an extracted first layer; storing the extracted first layer in a first track in a file; extracting remaining layers of the two or more layers from the video bitstream to generate extracted remaining layers; storing the extracted remaining layers in the first track along the first layer as an sample auxiliary information associated with the first track; extracting parameters set from the video bitstream to generate extracted parameters of first layer; re-writing and storing the extracted parameters of first layer in the first track; associating the extracted parameters with the first layer using a first configuration box; storing the first configuration box in the sample entry of the first track; re-writing and storing the extracted parameters of remaining layers in the first track associating the extracted parameters with the remaining layer using a second configuration box; creating a restricted scheme using SchemeTypeBox with the scheme_type parameter in the SchemeTypeBox indicating the presence of remaining layers in the sample auxiliary information of the first track; creating a new SecondaryLayerSAIBox or MultiLayerSAIBox present in the SampleEntry of the first track; and storing the second configuration box in the SecondaryLayerSAIBox or MultiLayerSAIBox.

Example 82: A method comprising: receiving a file; determining a presence for a first layer and a remaining layers data from the file; extracting data and related parameters sets of the first layer from a first configuration box; extracting data and related parameters sets of the remaining layers from a second configuration box; wherein a restricted scheme using SchemeTypeBox is created with the scheme_type parameter in the SchemeTypeBox for indicating the presence of remaining layers; and wherein a new SecondaryLayerSAIBox or MultiLayerSAIBox present in the SampleEntry stores the second configuration box in the SecondaryLayerSAIBox or MultiLayerSAIBox.

Example 83: An apparatus comprising means for performing methods as described in any of the examples 42 to 78, 79 to 80, 81, or 82.

Example: 84: A computer readable medium comprising program instructions that, when executed by an apparatus, cause the apparatus to perform method as described in any of the examples 42 to 78, 79 to 80, 81, or 82.

Example: 85: A computer readable medium of example 84, wherein the computer readable medium comprises a non-transitory computer readable medium.

### BRIEF DESCRIPTION OF THE DRAWINGS

The foregoing embodiments and other features are explained in the following description, taken in connection with the accompanying drawings, wherein:

FIG. 1 shows schematically an apparatus employing embodiments of the examples described herein.

FIG. 2 shows schematically a user equipment suitable for employing embodiments of the examples described herein.

FIG. 3 further shows schematically electronic devices employing embodiments of the examples described herein connected using wireless and wired network connections.

FIG. 4 is an example apparatus, which may be implemented in hardware, and is caused to, implement examples described herein.

FIG. 5 shows a representation of an example of non-volatile memory media used to store instructions that implement the examples described herein.

FIG. 6 is an example method to implement the embodiments described herein, in accordance with an embodiment.

FIG. 7 is an example method to implement the embodiments described herein, in accordance with another embodiment.

FIG. 8 is an example method to implement the embodiments described herein, in accordance with yet another embodiment.

FIG. 9 is an example method to implement the embodiments described herein, in accordance with still another embodiment.

### DETAILED DESCRIPTION OF EXAMPLE EMBODIMENTS

The following acronyms and abbreviations that may be found in the specification and/or the drawing figures are defined as follows (the abbreviations may be appended with each other or with other characters using e.g. a hyphen or dash (-), and may be case insensitive):
4CC four character code
5G fifth generation cellular network technology
5GC 5G core network
a.k.a. also known as
AVC advanced video coding
CU coding unit
DSP digital signal processor
DU distributed unit
eNB (or eNodeB) evolved Node B (for example, an LTE base station)
EN-DC E-UTRA-NR dual connectivity
en-gNB or En-gNB node providing NR user plane and control plane protocol terminations towards the UE, and acting as secondary node in EN-DC
E-UTRA evolved universal terrestrial radio access, for example, the LTE radio access technology
F1 or F1-C interface between CU and DU control interface
gNB (or gNodeB) base station for 5G/NR, for example, a node providing NR user plane and control plane protocol terminations towards the UE, and connected via the NG interface to the 5GC
IEC International Electrotechnical Commission
IoT internet of things
ISO International Organization for Standardization
ISOBMFF ISO base media file format
JPEG joint photographic experts group
LTE long-term evolution
mdat MediaDataBox
MIME Multipurpose Internet Mail Extension
MME mobility management entity
moov MovieBox
MP4 file format for MPEG-4 Part 14 files
MPEG moving picture experts group
MPEG-2 H.222/H.262 as defined by the ITU
MPEG-4 audio and video coding standard for ISO/IEC 14496
ng or NG new generation
ng-eNB or NG-eNB new generation eNB
NR new radio (5G radio)
N/W or NW network
PDCP packet data convergence protocol
PHY physical layer
PNG portable network graphics
RAN radio access network
RFC request for comments
RLC radio link control
RRC radio resource control
RRH remote radio head
RU radio unit
Rx receiver
SDAP service data adaptation protocol
SGW serving gateway
SMF session management function
SPS sequence parameter set
SVC scalable video coding
SI interface between eNodeBs and the EPC
trak TrackBox
Tx transmitter
UE user equipment
UICC Universal Integrated Circuit Card
UPF user plane function
URL uniform resource locator
X2 interconnecting interface between two eNodeBs in LTE network
Xn interface between two NG-RAN nodes

Some embodiments will now be described more fully hereinafter with reference to the accompanying drawings, in which some, but not all, embodiments may be shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms ‘data,’ ‘content,’ ‘information,’ and similar terms may be used interchangeably to refer to data capable of being transmitted, received and/or stored in accordance with embodiments of the present invention. Thus, use of any such terms should not be taken to limit the spirit and scope of embodiments.

Described herein is a method and apparatus for enabling backward compatible multilayer bitstream in single layer tracks.

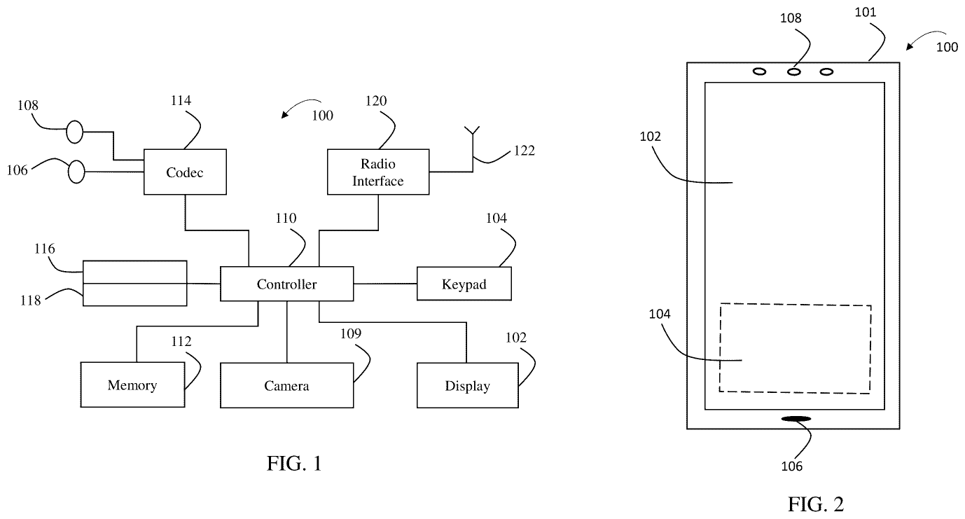

The following describes in detail a suitable apparatus and possible method for enabling backward compatible multilayer bitstream in single layer tracks according to embodiments. In this regard reference is first made to FIG. 1 and FIG. 2, where FIG. 1 shows an example block diagram of an electronic device or apparatus 100. The apparatus 100 may be an Internet of Things (IoT) apparatus configured to perform various functions, such as for example, gathering information by one or more sensors, receiving or transmitting information, analyzing information gathered or received by the apparatus, or the like. The apparatus may comprise a video coding system, which may incorporate a codec. FIG. 2 shows a layout of an apparatus according to an example embodiment. The elements of FIG. 1 and FIG. 2 are explained next.

The apparatus 100 may for example be a mobile terminal or user equipment of a wireless communication system, a sensor device, a tag, or other lower power device. However, it would be appreciated that embodiments of the examples described herein may be implemented within any electronic device or apparatus which may process data by neural networks.

The apparatus 100 may comprise a housing 101 for incorporating and protecting the device. The apparatus 100 further may comprise a display 102 in the form of a liquid crystal display. In other embodiments of the examples described herein the display may be any suitable display technology suitable to display an image or video. The apparatus 100 may further comprise a keypad 104. In other embodiments of the examples described herein any suitable data or user interface mechanism may be employed. For example the user interface may be implemented as a virtual keyboard or data entry system as part of a touch-sensitive display.

The apparatus may comprise a microphone 106 or any suitable audio input which may be a digital or analog signal input. The apparatus 100 may further comprise an audio output device which in embodiments of the examples described herein may be any one of: an earpiece 108, speaker, or an analog audio or digital audio output connection. The apparatus 100 may also comprise a battery (or in other embodiments of the examples described herein the device may be powered by any suitable mobile energy device such as solar cell, fuel cell or clockwork generator). The apparatus 100 may further comprise a camera 109 capable of recording or capturing images and/or video. The apparatus 100 may further comprise an infrared port for short range line of sight communication to other devices. In other embodiments the apparatus 100 may further comprise any suitable short range communication solution such as for example a Bluetooth wireless connection or a USB/firewire wired connection.

The apparatus 100 may comprise a controller 110, processor or processor circuitry for controlling the apparatus 100. The controller 110 may be connected to memory 112 which in embodiments of the examples described herein may store both data in the form of image and audio data and/or may also store instructions for implementation on the controller 110. The controller 110 may further be connected to codec circuitry 114 suitable for carrying out coding and/or decoding of audio and/or video data or assisting in coding and/or decoding carried out by the controller.

The apparatus 100 may further comprise a card reader 118 and a smart card 116, for example a UICC and UICC reader for providing user information and being suitable for providing authentication information for authentication and authorization of the user at a network.

The apparatus 100 may comprise radio interface circuitry 120 connected to the controller and suitable for generating wireless communication signals for example for communication with a cellular communications network, a wireless communications system or a wireless local area network. The apparatus 100 may further comprise an antenna 122 connected to the radio interface circuitry 120 for transmitting radio frequency signals generated at the radio interface circuitry 120 to other apparatus(es) and/or for receiving radio frequency signals from other apparatus(es).

The apparatus 100 may comprise a camera capable of recording or detecting individual frames which are then passed to the codec circuitry 114 or the controller for processing. The apparatus may receive the video image data for processing from another device prior to transmission and/or storage. The apparatus 100 may also receive either wirelessly or by a wired connection the image for coding/decoding. The structural elements of apparatus 100 described above represent examples of means for performing a corresponding function.

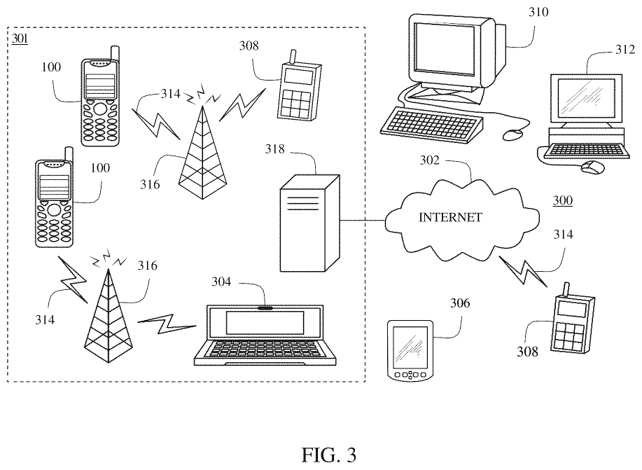

With respect to FIG. 3, an example of a system within which embodiments of the examples described herein can be utilized is shown. The system 300 comprises multiple communication devices which can communicate through one or more networks. The system 300 may comprise any combination of wired or wireless networks including, but not limited to a wireless cellular telephone network (such as a GSM, UMTS, CDMA, LTE, 4G, 5G network, etc.), a wireless local area network (WLAN) such as defined by any of the IEEE 802.x standards, a Bluetooth personal area network, an Ethernet local area network, a token ring local area network, a wide area network, and the Internet.

The system 300 may include both wired and wireless communication devices and/or apparatus 100 suitable for implementing embodiments of the examples described herein.

For example, the system shown in FIG. 3 shows a mobile telephone network 301 and a representation of the internet 302. Connectivity to the internet 302 may include, but is not limited to, long range wireless connections, short range wireless connections, and various wired connections including, but not limited to, telephone lines, cable lines, power lines, and similar communication pathways.

The example communication devices shown in the system 300 may include, but are not limited to, an electronic device or apparatus 100, a combination of a personal digital assistant (PDA) and a mobile telephone 304, a PDA 306, an integrated messaging device (IMD) 308, a desktop computer 310, a notebook computer 312, or a head-mounted apparatus. The head-mounted apparatus may be a head-mounted display (HMD), or glasses having a device such as a camera configured to encode and/or decode images and/or video. The apparatus 100 may be stationary or mobile when carried by an individual who is moving. The apparatus 100 may also be located in a mode of transport including, but not limited to, a car, a truck, a taxi, a bus, a train, a boat, an airplane, a bicycle, a motorcycle or any similar suitable mode of transport.

The embodiments may also be implemented in a set-top box; e.g., a digital TV receiver, which may/may not have a display or wireless capabilities, in tablets or (laptop) personal computers (PC), which have hardware and/or software to process neural network data, in various operating systems, and in chipsets, processors, DSPs and/or embedded systems offering hardware/software based coding.

Some or further apparatus may send and receive calls and messages and communicate with service providers through a wireless connection 314 to a base station 316. The base station 316 may be connected to a network server 318 that allows communication between the mobile telephone network 301 and the internet 302. The system may include additional communication devices and communication devices of various types.

The communication devices may communicate using various transmission technologies including, but not limited to, code division multiple access (CDMA), global systems for mobile communications (GSM), universal mobile telecommunications system (UMTS), time divisional multiple access (TDMA), frequency division multiple access (FDMA), transmission control protocol-internet protocol (TCP-IP), short messaging service (SMS), multimedia messaging service (MMS), email, instant messaging service (IMS), Bluetooth, IEEE 802.11, 3GPP Narrowband IoT and any similar wireless communication technology. A communications device involved in implementing various embodiments of the examples described herein may communicate using various media including, but not limited to, radio, infrared, laser, cable connections, and any suitable connection.

In telecommunications and data networks, a channel may refer either to a physical channel or to a logical channel. A physical channel may refer to a physical transmission medium such as a wire, whereas a logical channel may refer to a logical connection over a multiplexed medium, capable of conveying several logical channels. A channel may be used for conveying an information signal, for example a bitstream, from one or several senders (or transmitters) to one or several receivers.

The embodiments may also be implemented in so-called IoT devices. The Internet of Things (IoT) may be defined, for example, as an interconnection of uniquely identifiable embedded computing devices within the existing Internet infrastructure. The convergence of various technologies has and may enable many fields of embedded systems, such as wireless sensor networks, control systems, home/building automation, etc. to be included in the Internet of Things (IoT). In order to utilize the Internet IoT devices are provided with an IP address as a unique identifier. IoT devices may be provided with a radio transmitter, such as a WLAN or Bluetooth transmitter or a RFID tag. Alternatively, IoT devices may have access to an IP-based network via a wired network, such as an Ethernet-based network or a power-line connection (PLC).

Having thus introduced a suitable but non-limiting technical context for the practice of the example embodiments of the present disclosure, example embodiments will now be described in detail.

Features and/or embodiments as described herein may generally relate to the ISO base media file format (ISOBMFF). However, it should be noted that the embodiments may also relate to other media file formats.

### Iso Base Media File Format

Available media file format standards include International Standards Organization (ISO) base media file format (ISO/IEC 14496-12, which may be abbreviated ISOBMFF), Moving Picture Experts Group (MPEG)-4 file format (ISO/IEC 14496-14, also known as the MP4 format), and the file format for NAL (Network Abstraction Layer) unit structured video (ISO/IEC 14496-15).

Some concepts, structures, and specifications of ISOBMFF are described below as an example of a container file format, based on which some embodiments may be implemented. The aspects of the disclosure are not limited to ISOBMFF, but rather the description is given for one possible basis on top of which at least some embodiments may be partly or fully realized.

A basic building block in the ISO base media file format is called a box. Each box has a header and a payload. The box header indicates the type of the box and the size of the box in terms of bytes. Box type is typically identified by an unsigned 32-bit integer, interpreted as a four character code (4CC). A box may enclose other boxes, and the ISO file format specifies which box types are allowed within a box of a certain type. Furthermore, the presence of some boxes may be mandatory in each file, while the presence of other boxes may be optional. Additionally, for some box types, it may be allowable to have more than one box present in a file. Thus, the ISO base media file format may be considered to specify a hierarchical structure of boxes.

In files conforming to the ISO base media file format, the media data may be provided in one or more instances of MediaDataBox (‘mdat’) and the MovieBox (‘moov’) may be used to enclose the metadata for timed media. In some cases, for a file to be operable, both of the ‘mdat’ and ‘moov’ boxes may be required to be present. The ‘moov’ box may include one or more tracks, and each track may reside in one corresponding TrackBox (‘trak’). Each track is associated with a handler, identified by a four-character code, specifying the track type. Video, audio, and image sequence tracks can be collectively called media tracks, and they include an elementary media stream. Other track types comprise hint tracks and timed metadata tracks.

Tracks comprise samples, such as audio or video frames. For video tracks, a media sample may correspond to a coded picture or an access unit.

A media track refers to samples (which may also be referred to as media samples) formatted according to a media compression format (and its encapsulation to the ISO base media file format). A hint track refers to hint samples, including cookbook instructions for constructing packets for transmission over an indicated communication protocol. A timed metadata track may refer to samples describing referred media and/or hint samples.

The ‘trak’ box includes in its hierarchy of boxes the SampleDescriptionBox, which gives detailed information about the coding type used, and any initialization information needed for that coding. The SampleDescriptionBox includes an entry-count and as many sample entries as the entry-count indicates. The format of sample entries is track-type specific but derived from generic classes (e.g. VisualSampleEntry, AudioSampleEntry). Which type of sample entry form is used for derivation of the track-type specific sample entry format is determined by the media handler of the track.

A sample entry may comprise a configuration box, which itself may comprise a configuration record. The configuration record may comprise information that may be used to configure a decoder instance for decoding the samples mapped to the sample entry.

A sample table includes all the time and data indexing of the media samples in a track. Using the tables here, it is possible to locate samples in time, determine their type (e.g. I-frame or not), and determine their size, container, and offset into that container.

If the track that includes the SampleTableBox, refers to no data, then the SampleTableBox does not need to include any sub-boxes (this is not a very useful media track).

If the track that the SampleTableBox is contained in, refers to data, then the following sub-boxes are required: SampleDescriptionBox, SampleSizeBox (or CompactSampleSizeBox), SampleToChunkBox, and ChunkOffsetBox (or ChunkLargeOffsetBox). Further, the SampleDescriptionBox shall include at least one entry. A SampleDescriptionBox is required because it includes the data reference index field, which indicates which DataEntry to use to retrieve the media samples. Without the SampleDescriptionBox, it is not possible to determine where the media samples are stored.

The syntax of SampleTableBox in ISOBMFF is as follows:

aligned(8) class SampleTableBox extends Box(‘stbl’) {
}

A SampleSizeBox includes the sample count and a table giving the size in bytes of each sample. This allows the media data itself to be unframed. The total number of samples in the media is always indicated in the sample count.

There are two variants of the sample size box. The first variant has a fixed size 32-bit field for representing the sample sizes; it permits defining a constant size for all samples in a track. The second variant permits smaller size fields, to save space when the sizes are varying but small. One of these boxes shall be present; the first version is preferred for maximum compatibility.

A sample size of zero is not prohibited in general, but it must should be valid and defined for the coding system, as defined by the sample entry, that the sample belongs to.

The syntax of SampleSizeBox in ISOBMFF is as follows:

```
aligned(8) class SampleSizeBox extends FullBox(‘stsz’, version = 0, 0) {
  unsigned int(32) sample_size;
  unsigned int(32) sample_count;
  if (sample_size==0) {
    for (i=1; i <= sample_count; i++) {
    unsigned int(32) entry_size;
    }
  }
}
```

The semantics of SampleSizeBox structure in ISOBMFF is as follows:
version is an integer that specifies the version of this box;
sample_size is integer specifying the default sample size. When all the samples are the same size, this field includes that size value. When this field is set to 0, then the samples have different sizes, and those sizes are stored in the sample size table. When this field is not 0, it specifies the constant sample size, and no array follows.
sample_count is an integer that gives the number of samples in the track; when sample-size is 0, then it is also the number of entries in the following table.
entry_size is an integer specifying the size of a sample, indexed by its number.

The syntax of CompactSampleSizeBox in ISOBMFF is as follows:

| aligned(8) class CompactSampleSizeBox | |
|---|---|
| extends FullBox(‘stz2’, version = 0, 0) { | |
| unsigned int(24) | reserved = 0; |
| unsigned int(8) | field_size; |
| unsigned int(32) | sample_count; |

```
  for (i=1; i <= sample_count; i++) {
    unsigned int(field_size) entry_size;
  }
}
```

The semantics of CompactSampleSizeBox structure in ISOBMFF is as follows:
version is an integer that specifies the version of this box;
field_size is an integer specifying the size in bits of the entries in the following table; it shall take the value 4, 8 or 16. When the value 4 is used, then each byte includes two values:
entry[i]<<4+entry[i+1]; when the sizes do not fill an integral number of bytes, the last byte is padded with zeros.
sample_count is an integer that gives the number of entries in the following table
entry_size is an integer specifying the size of a sample, indexed by its number.

The track reference mechanism can be used to associate tracks with each other. The TrackReferenceBox (‘tref’) includes box(es), each of which provides a reference from the including track to a set of other tracks. These references are labeled through the box type (e.g., the four-character code of the box) of the contained box(es).

The ISO Base Media File Format includes three mechanisms for timed metadata that can be associated with particular samples: sample groups, timed metadata tracks, and sample auxiliary information. A derived specification may provide similar functionality with one or more of these three mechanisms.

A sample grouping in the ISO base media file format and its derivatives, such as ISO/IEC 14496-15, may be defined as an assignment of each sample in a track to be a member of one sample group, based on a grouping criterion. A sample group in a sample grouping is not limited to being contiguous samples and may include non-adjacent samples. As there may be more than one sample grouping for the samples in a track, each sample grouping may have a type field to indicate the type of grouping. Sample groupings may be represented by two linked data structures: (1) a SampleToGroupBox (sbgp box) represents the assignment of samples to sample groups; and (2) a SampleGroupDescriptionBox (sgpd box) includes a sample group entry for each sample group describing the properties of the group. There may be multiple instances of the SampleToGroupBox and SampleGroupDescriptionBox based on different grouping criteria. These may be distinguished by a type field used to indicate the type of grouping. SampleToGroupBox may comprise a grouping_type_parameter field that can be used e.g. to indicate a sub-type of the grouping.

In ISOMBFF, an edit list provides a mapping between the presentation timeline and the media timeline. Among other things, an edit list provides for the linear offset of the presentation of samples in a track, provides for the indication of empty times and provides for a particular sample to be dwelled on for a certain period of time. The presentation timeline may be accordingly modified to provide for looping, such as for the looping videos of the various regions of the scene. One example of the box that includes the edit list, the EditListBox, is provided below:

aligned(8) class EditListBox extends FullBox(‘elst’, version, flags) {
unsigned int(32) entry_count;
for (i=1; i <= entry_count; i++) {
if (version==1) {
unsigned int(64) segment_duration;
int(64) media_time;
} else { // version==0
unsigned int(32) segment_duration;
int(32) media_time;
}
int(16) media_rate_integer;
int(16) media_rate_fraction = 0;
}
}
In ISOBMFF, an EditListBox may be contained in EditBox,
which is contained in TrackBox
(‘trak’).

In this example of the edit list box, flags specifies the repetition of the edit list. By way of example, setting a specific bit within the box flags (the least significant bit, e.g., flags & 1 in ANSI-C notation, where & indicates a bit-wise AND operation) equal to 0 specifies that the edit list is not repeated, while setting the specific bit (e.g., flags & 1 in ANSI-C notation) equal to 1 specifies that the edit list is repeated. The values of box flags greater than 1 may be defined to be reserved for future extensions. As such, when the edit list box indicates the playback of zero or one samples, (flags & 1) shall be equal to zero. When the edit list is repeated, the media at time 0 resulting from the edit list follows immediately the media having the largest time resulting from the edit list such that the edit list is repeated seamlessly.

In ISOBMFF, a Track group enables grouping of tracks based on certain characteristics or the tracks within a group have a particular relationship. Track grouping, however, does not allow any image items in the group.

The syntax of TrackGroupBox in ISOBMFF is as follows:

```
aligned(8) class TrackGroupBox extends Box(‘trgr’) {
}
aligned(8) class TrackGroupTypeBox(unsigned int(32)
track_group_type) extends
FullBox(track_group_type, version = 0, flags = 0)
{
  unsigned int(32) track_group_id;
  // the remaining data may be specified for a particular
  track_group_type
}
```

track_group_type indicates the grouping_type and shall be set to one of the following values, or a value registered, or a value from a derived specification or registration:
‘msrc’ indicates that this track belongs to a multi-source presentation. The tracks that have the same value of track_group_id within a TrackGroupTypeBox of track_group_type ‘msrc’ are mapped as being originated from the same source. For example, a recording of a video telephony call may have both audio and video for both participants, and the value of track_group_id associated with the audio track and the video track of one participant differs from value of track_group_id associated with the tracks of the other participant.

The pair of track_group_id and track_group_type identifies a track group within the file. The tracks that include a particular TrackGroupTypeBox having the same value of track_group_id and track_group_type belong to the same track group.

The Entity grouping is similar to track grouping but enables grouping of both tracks and image items in tha same group.

The syntax of EntityToGroupBox in ISOBMFF is as follows.

```
aligned(8) class EntityToGroupBox(grouping_type, version, flags)
extends FullBox(grouping_type, version, flags) {
  unsigned int(32) group_id;
  unsigned int(32) num_entities_in_group;
  for(i=0; i<num_entities_in_group; i++)
    unsigned int(32) entity_id;
}
```

group_id is a non-negative integer assigned to the particular grouping that shall not be equal to any group_id value of any other EntityToGroupBox, any item_ID value of the hierarchy level (file, movie. or track) that includes the GroupsListBox, or any track_ID value (when the GroupsListBox is contained in the file level).

num_entities_in_group specifies the number of entity_id values mapped to this entity group.

entity_id is resolved to an item, when an item with item_ID equal to entity_id is present in the hierarchy level (file, movie or track) that includes the GroupsListBox, or to a track, when a track with track_ID equal to entity_id is present and the GroupsListBox is contained in the file level.

Files conforming to the ISOBMFF may include any non-timed objects, referred to as items, meta items, or metadata items, in a meta box (four-character code: ‘meta’). While the name of the meta box refers to metadata, items can generally include metadata or media data. The meta box may reside at the top level of the file, within a movie box (four-character code: ‘moov’), and within a track box (four-character code: ‘trak’), but at most one meta box may occur at each of the file level, movie level, or track level. The meta box may be required to include a ‘hdlr’ box indicating the structure or format of the ‘meta’ box contents. The meta box may list and characterize any number of items that can be referred and each one of them can be associated with a file name and are uniquely identified with the file by item identifier (item_id) which is an integer value. The metadata items may be for example stored in the ‘idat’ box of the meta box or in an ‘mdat’ box or reside in a separate file. When the metadata is located external to the file then its location may be declared by the DataInformationBox (four-character code: ‘dinf’). In the specific case that the metadata is formatted using eXtensible Markup Language (XML) syntax and is required to be stored directly in the MetaBox, the metadata may be encapsulated into either the XMLBox (four-character code: ‘xml’) or the BinaryXMLBox (four-character code: ‘bxml’). An item may be stored as a contiguous byte range, or it may be stored in several extents, each being a contiguous byte range. In other words, items may be stored fragmented into extents, e.g. to enable interleaving. An extent is a contiguous subset of the bytes of the resource. The resource can be formed by concatenating the extents.

The sample description table gives detailed information about the coding type used, and any initialization information needed for that coding. The syntax of the sample entry used is determined by both the format field and the media handler type.

The information stored in the SampleDescriptionBox after the entry-count is both track-type specific, and can also have variants within a track type (e.g. different codings may use different specific information after some common fields, even within a video track).

Which type of sample entry form is used is determined by the media handler, using a suitable form. Multiple descriptions may be used within a track.

The definition of sample entries specifies boxes in a particular order, and this is usually also followed in derived specifications. For maximum compatibility, writers should construct files respecting the order both within specifications and as implied by the inheritance, whereas readers should be prepared to accept any box order.

All SampleEntry boxes may include “extra boxes” not explicitly defined in the box syntax of this or derived specifications. When present, such boxes shall follow all defined fields and should follow any defined contained boxes. Decoders shall presume a sample entry box could include extra boxes and shall continue parsing as though they are present until the including box length is exhausted.

An optional BitRateBox may be present in any SampleEntry to signal the bit rate information of a stream. This can be used for buffer configuration.

All string fields shall be of type utf8string and null-terminated, even when unused. “Optional” means there is at least one null byte.

Entries that identify the format by MIME type, such as a TextSubtitleSampleEntry, TextMetaDataSampleEntry, or SimpleTextSampleEntry, all of which include a MIME type, may be used to identify the format of streams for which a MIME type applies. A MIME type applies when the contents of the string in the optional configuration box (without its null termination), followed by the contents of a set of samples, starting with a sync sample and ending at the sample immediately preceding a sync sample, are concatenated in their entirety, and the result meets the decoding requirements for documents of that MIME type. Non-sync samples should be used only when that format specifies the behaviour of ‘progressive decoding’, and then the sample times indicate when the results of such progressive decoding should be presented (according to the media type).

In some classes derived from SampleEntry, namespace and schema_location are used both to identify the XML document content and to declare “brand” or profile compatibility. Multiple namespace identifiers indicate that the track conforms to the specification represented by each of the identifiers, some of which may identify supersets of the features present. A decoder should be able to decode all the namespaces in order to be able to decode and present correctly the media associated with this sample entry.

### Syntax

```
aligned(8) abstract class SampleEntry (unsigned int(32) format)
  extends Box(format)
{
  const unsigned int(8) reserved[6] = 0;
  unsigned int(16) data_reference_index;
}
class BitRateBox extends Box(‘btrt’)
{
  unsigned int(32) bufferSizeDB;
  unsigned int(32) maxBitrate;
  unsigned int(32) avgBitrate;
}
aligned(8) class SampleDescriptionBox( )
  extends FullBox(‘stsd’, version, 0)
{
  int i;
  unsigned int(32) entry_count;
  for (i = 1 ; i <= entry_count ; i++){
    SampleEntry( ); // an instance of a class derived from SampleEntry
  }
}
```

### Semantics

version is set to zero. A version number of 1 shall be treated as a version of 0.

entry_count is an integer that gives the number of entries in the following table.

SampleEntry is the appropriate sample entry.

data_reference_index is an integer that includes the index of the DataEntry to use to retrieve data associated with samples that use this sample entry. Data entries are stored in DataReferenceBoxes. The index ranges from 1 to the number of data entries.

bufferSizeDB gives the size of the decoding buffer for the media stream in bytes.

maxBitrate gives the maximum rate in bits/second over any window of one second; this is a measured value for stored content, or a value that a stream is configured not to exceed; the stream shall not exceed this bitrate.

avgBitrate gives the average rate in bits/second of the stream; this is a measured value (cumulative over the entire presentation) for stored content, or the configured target average bitrate for a stream.

Video tracks use VisualSampleEntry.

In video tracks, the frame_count field shall be 1 unless the specification for the media format explicitly documents this template field and permits larger values. That specification must document both how the individual frames of video are found (their size information) and their timing established. That timing might be as simple as dividing the sample duration by the frame count to establish the frame duration.

The width and height in the video sample entry document the pixel counts that the codec will deliver; this enables the allocation of buffers. Since these are counts they do not take into account pixel aspect ratio.

### Syntax

```
class VisualSampleEntry(codingname) extends SampleEntry (codingname)
{
  unsigned int(16) pre_defined = 0;
  const unsigned int(16) reserved = 0;
```

| unsigned int(32) | pre_defined[3] = 0; | |
|---|---|---|
| unsigned int(16) | width; | |
| unsigned int(16) | height; | |
| template unsigned int(32) | horizresolution = 0x00480000; | // 72 dpi |
| template unsigned int(32) | vertresolution = 0x00480000; | // 72 dpi |

| | |
|---|---|
| const unsigned int(32) | reserved = 0; |
| template unsigned int(16) | frame_count = 1; |

uint(8) compressorname[32];

| | |
|---|---|
| template unsigned int(16) | depth = 0x0018; |

```
  int(16) pre_defined = −1;
  // other boxes from derived specifications
```

| | | |
|---|---|---|
| CleanApertureBox | clap; | // optional |
| PixelAspectRatioBox | pasp; | // optional |

}

### Semantics

resolution fields give the resolution of the image in pixels-per-inch, as a fixed 16.16 number
frame_count indicates how many frames of compressed video are stored in each sample. The default is 1, for one frame per sample; it may be more than 1 for multiple frames per sample
compressorname is a name, for informative purposes. It is formatted in a fixed 32-byte field, with the first byte set to the number of bytes to be displayed, followed by that number of bytes of displayable data encoded using UTF-8, and then padding to complete 32 bytes total (including the size byte). The field may be set to 0.
depth takes one of the following values
0x0018—images are in colour with no alpha
width and height are the maximum visual width and height of the stream described by this sample entry, in pixels

In order to handle situations where the file author requires certain actions on the player or renderer, a mechanism is specified that enables players to simply inspect a file to find out such requirements for rendering a bitstream and stops legacy players from decoding and rendering files that require further processing. The mechanism applies to any type of video codec.

The mechanism is similar to the content protection transformation where sample entries are hidden behind generic sample entries, ‘encv’, ‘enca’, etc., indicating encrypted or encapsulated media. The analogous mechanism for restricted video uses a transformation with the generic sample entry ‘resv’. The method may be applied when the content should only be decoded by players that present it correctly.

Restricted sample entry transformation

A restricted sample entry is defined as a sample entry on which the following transformation procedure has been applied:
1) The four character code of the sample entry is replaced by a sample entry code as defined below.
2) A RestrictedSchemeInfoBox is added to the sample entry, leaving all other boxes unmodified.
3) The original sample entry type is stored within an OriginalFormatBox contained in the RestrictedSchemelnfoBox.

Table 1 illustrates restricted sample-entry codes.

TABLE 1

| Stream (Track) | Sample-Entry | SampleEntry |
|---|---|---|
| Type | Code | Class |
| Video | resv | VisualSampleEntry |
| Audio | resa | AudioSampleEntry or |
| | | AudioSampleEntryV1 |
| Metadata | resm | MetaDataSampleEntry |
| Text | rest | SimpleTextSampleEntry |
| Subtitle | resu | XMLSubtitleSampleEntry |
| System^{a} | ress | |
| Font | resf | FontSampleEntry |
| Haptics | resp | HapticSampleEntry |
| Volumetric visual | res3 | VolumetricVisualSampleEntry |

^{a}System streams are defined in ISO/IEC 14496-14^{Error! Reference source not found.}.

A RestrictedSchemeInfoBox is formatted exactly the same as a ProtectionSchemeInfoBox, except that is uses the identifier ‘rinf’ instead of ‘sinf’ (see below).

The original sample entry type is contained in the OriginalFormatBox located in the RestrictedSchemelnfoBox (in an identical way to the ProtectionSchemeInfoBox for encrypted media).

The exact nature of the restriction is defined in the SchemeTypeBox, and the data needed for that scheme is stored in the SchemeInformationBox, again, analogously to protection information.

Restriction and protection can be applied at the same time. The order of the transformations follows from the four-character code of the sample entry. For instance, when the sample entry type is ‘resv’, undoing the above transformation may result in a sample entry type ‘ency’, indicating that the media is protected.

If the file author only wants to provide advisory information without stopping legacy players from playing the file, the RestrictedSchemeInfoBox may be placed inside the sample entry without transforming the four character code. In this case it is not necessary to include an OriginalFormatBox.

The RestrictedSchemeInfoBox includes all the information required both to understand the restriction scheme applied and its parameters. It also documents the original (un-transformed) sample entry type of the media. The RestrictedSchemeInfoBox is a container Box. It is mandatory in a sample entry that uses a code indicating a restricted stream, e.g., ‘resv’.

When used in a restricted sample entry, this box shall include the OriginalFormatBox to document the original sample entry type and a SchemeTypeBox. A SchemeInformationBox may be required depending on the restriction scheme.

```
aligned(8) class RestrictedSchemeInfoBox(fmt) extends Box(‘rinf’)
{
  OriginalFormatBox original_format(fmt);
  SchemeTypeBox scheme_type_box;
  SchemeInformationBox info; // optional
}
```

The OriginalFormatBox includes the four character code of the original un-transformed sample entry.

### Syntax

```
aligned(8) class OriginalFormatBox(codingname) extends Box (‘frma’)
{
      unsigned int(32) data_format = codingname;
      // format of decrypted, encoded data (in case of protection)
      // or un-transformed sample entry (in case of restriction
      // and complete track information)
}
The SchemeTypeBox identifies the protection or restriction scheme.
  Syntax
  aligned(8) class SchemeTypeBox extends FullBox(‘schm’, 0, flags)
  {
    unsigned int(32) scheme_type; // 4CC identifying the scheme
    unsigned int(32) scheme_version; // scheme version
    if (flags & 0x000001) {
      utf8string scheme_uri; // browser uri
    }
  }
```

scheme_type is the code defining the protection or restriction scheme, normally expressed as a four character code;
scheme_version is the version of the scheme (used to create the content)
scheme_URI is an absolute URI allowing for the option of directing the user to a web-page when they do not have the scheme installed on their system.

The SchemeInformationBox is a container Box that is only interpreted by the scheme being used. Any information the encryption or restriction system needs is stored here. The content of this box is a series of boxes whose type and format are defined by the scheme declared in the SchemeTypeBox.

### Syntax

aligned(8) class SchemeInformationBox extends Box(‘schi’)
{
Box scheme_specific_data[ ];
}

### Video Coding

A video codec includes an encoder and a decoder. The encoder transforms the input video into a compressed representation suited for storage/transmission. The decoder can uncompress the compressed video representation back into a viewable form. A video encoder and/or a video decoder may also be separate from each other (e.g., need not form a codec). The encoder may discard some information in the original video sequence in order to represent the video in a more compact form (that is, at a lower bitrate).

Hybrid video encoders, for example many encoder implementations of ITU-T H.263 and H.264, may encode the video information in two phases. Firstly, pixel values in a certain picture area (or “block”) are predicted, for example by motion compensation means (e.g., finding and indicating an area in one of the previously coded video frames that corresponds closely to the block being coded) or by spatial means (e.g., using the pixel values around the block to be coded in a specified manner). Secondly, the prediction error (e.g., the difference between the predicted block of pixels and the original block of pixels) is coded. This may be done by transforming the difference in pixel values using a specified transform (e.g. discrete cosine transform (DCT) or a variant of it), quantizing the coefficients and entropy coding the quantized coefficients. By varying the fidelity of the quantization process, the encoder can control the balance between the accuracy of the pixel representation (e.g., picture quality) and size of the resulting coded video representation (e.g., file size or transmission bitrate).

In temporal prediction, the sources of prediction are previously decoded pictures (a.k.a. reference pictures). In intra block copy (IBC; a.k.a. intra-block-copy prediction), prediction is applied similarly to temporal prediction, but the reference picture is the current picture and only previously decoded samples can be referred in the prediction process. Inter-layer or inter-view prediction may be applied similarly to temporal prediction, but the reference picture is a decoded picture from another scalable layer or from another view, respectively. In some cases, inter prediction may refer to temporal prediction only, while in other cases inter prediction may refer collectively to temporal prediction and any of intra block copy, inter-layer prediction, and inter-view prediction, provided that they are performed with the same or similar process as temporal prediction. Inter prediction or temporal prediction may sometimes be referred to as motion compensation or motion-compensated prediction.

Inter prediction, which may also be referred to as temporal prediction, motion compensation, or motion-compensated prediction, reduces temporal redundancy. In inter prediction, the sources of prediction are previously decoded pictures. Intra prediction utilizes the fact that adjacent pixels within the same picture are likely to be correlated. Intra prediction can be performed in spatial or transform domain; either sample values or transform coefficients can be predicted. Intra prediction is typically exploited in intra coding, where no inter prediction is applied.

One outcome of the coding procedure is a set of coding parameters, such as motion vectors and quantized transform coefficients. Many parameters can be entropy-coded more efficiently when they are predicted first from spatially or temporally neighboring parameters. For example, a motion vector may be predicted from spatially adjacent motion vectors, and only the difference relative to the motion vector predictor may be coded. Prediction of coding parameters and intra prediction may be collectively referred to as in-picture prediction.

The H.264/AVC standard was developed by the Joint Video Team (JVT) of the Video Coding Experts Group (VCEG) of the Telecommunications Standardization Sector of International Telecommunication Union (ITU-T) and the Moving Picture Experts Group (MPEG) of International Organisation for Standardization (ISO)/International Electrotechnical Commission (IEC). The H.264/AVC standard is published by both parent standardization organizations, and it is referred to as ITU-T Recommendation H.264 and ISO/IEC International Standard 14496-10, also known as MPEG-4 Part 10 Advanced Video Coding (AVC). There have been multiple versions of the H.264/AVC standard, integrating new extensions or features to the specification. These extensions include Scalable Video Coding (SVC) and Multiview Video Coding (MVC).

The High Efficiency Video Coding standard (which may be abbreviated HEVC or H.265/HEVC) was developed by the Joint Collaborative Team—Video Coding (JCT-VC) of VCEG and MPEG. The standard is published by both parent standardization organizations, and it is referred to as ITU-T Recommendation H.265 and ISO/IEC International Standard 23008-2, also known as MPEG-H Part 2 High Efficiency Video Coding (HEVC). Extensions to H.265/HEVC include scalable, multiview, three-dimensional, and fidelity range extensions, which may be referred to as SHVC, MV-HEVC, 3D-HEVC, and REXT, respectively. The references in this description to H.265/HEVC, SHVC, MV-HEVC, 3D-HEVC and REXT that have been made for the purpose of understanding definitions, structures or concepts of these standard specifications are to be understood to be references to the latest versions of these standards that were available before the date of this application, unless otherwise indicated.

SHVC, MV-HEVC, and 3D-HEVC use a common basis specification, specified in Annex F of the version 2 of the HEVC standard. This common basis comprises, for example, high-level syntax and semantics, for example specifying some of the characteristics of the layers of the bitstream, such as inter-layer dependencies, as well as decoding processes, such as reference picture list construction, including inter-layer reference pictures and picture order count derivation for multi-layer bitstream. Annex F may also be used in potential subsequent multi-layer extensions of HEVC.

It is to be understood that even though a video encoder, a video decoder, encoding methods, decoding methods, bitstream structures, and/or example embodiments may be described in the following with reference to specific extensions, such as SHVC and/or MV-HEVC, they are generally applicable to any multi-layer extensions of HEVC, and even more generally to any multi-layer video coding scheme.

The Versatile Video Coding standard (which may be abbreviated VVC, H.266, or H.266/VVC) was developed by the Joint Video Experts Team (JVET), which is a collaboration between the ISO/IEC MPEG and ITU-T VCEG. Extensions to VVC are presently under development.

A specification of the AV1 bitstream format and decoding process were developed by the Alliance of Open Media (AOM). The AV1 specification was published in 2018. AOM is reportedly working on the AV2 specification.

Some key definitions, bitstream and coding structures, and concepts of H.264/AVC and HEVC are described in this section as an example of a video encoder, decoder, encoding method, decoding method, and a bitstream structure, wherein the example embodiments may be implemented. Some of the key definitions, bitstream and coding structures, and concepts of H.264/AVC are the same as in HEVC; accordingly, they are described below jointly. The aspects of the present disclosure are not limited to H.264/AVC or HEVC, but rather the description is given for one possible basis on top of which the example embodiments may be partly or fully realized. Many aspects described below in the context of H.264/AVC or HEVC may apply to VVC, and the aspects of the present disclosure may hence be applied to VVC.

Similarly to many earlier video coding standards, the bitstream syntax and semantics, as well as the decoding process for error-free bitstreams, are specified in H.264/AVC and HEVC. The encoding process is not specified, but encoders must generate conforming bitstreams. Bitstream and decoder conformance can be verified with the Hypothetical Reference Decoder (HRD). The standards include coding tools that help in coping with transmission errors and losses, but the use of the tools in encoding is optional, and no decoding process has been specified for erroneous bitstreams.

The elementary unit for the input to an H.264/AVC or HEVC encoder, and the output of an H.264/AVC or HEVC decoder, respectively, is a picture. A picture given as an input to an encoder may also be referred to as a source picture, and a picture decoded by a decoded may be referred to as a decoded picture.

The source and decoded pictures are each comprised of one or more sample arrays, such as one of the following sets of sample arrays: luma (Y) only (monochrome); luma and two chroma (YCbCr or YCgCo); green, blue, and red (GBR, also known as RGB); or arrays representing other unspecified monochrome or tri-stimulus color samplings (for example, YZX, also known as XYZ).

In the following, these arrays may be referred to as luma (or L or Y) and chroma, where the two chroma arrays may be referred to as Cb and Cr, regardless of the actual color representation method in use. The actual color representation method in use can be indicated, for example, in a coded bitstream (e.g. using the Video Usability Information (VUI) syntax of H.264/AVC and/or HEVC). A component may be defined as an array or single sample from one of the three sample arrays (luma and two chroma), or an array or a single sample of the array that compose a picture in monochrome format.

In H.264/AVC and HEVC, a picture may either be a frame or a field. A frame comprises a matrix of luma samples and possibly the corresponding chroma samples. A field is a set of alternate sample rows of a frame and may be used as encoder input, for example when the source signal is interlaced. Chroma sample arrays may be absent (and hence monochrome sampling may be in use), or chroma sample arrays may be subsampled when compared to luma sample arrays.

Chroma formats may be summarized as follows. In monochrome sampling, there is only one sample array, which may be nominally considered the luma array. In 4:2:0 sampling, each of the two chroma arrays has half the height and half the width of the luma array. In 4:2:2 sampling, each of the two chroma arrays has the same height and half the width of the luma array. In 4:4:4 sampling, when no separate color planes are in use, each of the two chroma arrays has the same height and width as the luma array.

In H.264/AVC and HEVC, it is possible to code sample arrays as separate color planes into the bitstream and respectively decode separately coded color planes from the bitstream. When separate color planes are in use, each one of them is separately processed (by the encoder and/or the decoder) as a picture with monochrome sampling.

A partitioning may be defined as a division of a set into subsets such that each element of the set is in exactly one of the subsets.

When describing the operation of HEVC encoding and/or decoding, the following terms may be used. A coding block may be defined as an N×N block of samples for some value of N such that the division of a coding tree block into coding blocks is a partitioning. A coding tree block (CTB) may be defined as an N×N block of samples for some value of N such that the division of a component into coding tree blocks is a partitioning. A coding tree unit (CTU) may be defined as a coding tree block of luma samples, two corresponding coding tree blocks of chroma samples of a picture that has three sample arrays, or a coding tree block of samples of a monochrome picture or a picture that is coded using three separate color planes and syntax structures used to code the samples. A coding unit (CU) may be defined as a coding block of luma samples, two corresponding coding blocks of chroma samples of a picture that has three sample arrays, or a coding block of samples of a monochrome picture or a picture that is coded using three separate color planes and syntax structures used to code the samples. A CU with the maximum allowed size may be named as largest coding unit (LCU) or coding tree unit (CTU), and the video picture is divided into non-overlapping LCUs.

A CU includes one or more prediction units (PU) defining the prediction process for the samples within the CU and one or more transform units (TU) defining the prediction error coding process for the samples in the said CU. Typically, a CU includes a square block of samples with a size selectable from a predefined set of possible CU sizes. Each PU and TU can be further split into smaller PUs and TUs in order to increase granularity of the prediction and prediction error coding processes, respectively. Each PU has prediction information associated with it defining what kind of a prediction is to be applied for the pixels within that PU (e.g. motion vector information for inter predicted PUs and intra prediction directionality information for intra predicted PUs).

Each TU can be associated with information describing the prediction error decoding process for the samples within the said TU (including, e.g., DCT coefficient information). It may be signaled at the CU level whether prediction error coding is applied or not for each CU. In the case there is no prediction error residual associated with the CU, it can be considered there are no TUs for the said CU. The division of the image into CUs, and division of CUs into PUs and Tus, may be signaled in the bitstream, allowing the decoder to reproduce the intended structure of these units.

In HEVC, a picture can be partitioned in tiles, which are rectangular and include an integer number of LCUs. In HEVC, the partitioning to tiles forms a regular grid, where heights and widths of tiles differ from each other by one LCU at the maximum. In HEVC, a slice is defined to be an integer number of coding tree units contained in one independent slice segment and all subsequent dependent slice segments (if any) that precede the next independent slice segment (if any) within the same access unit. In HEVC, a slice segment is defined to be an integer number of coding tree units ordered consecutively in the tile scan and contained in a single NAL unit. The division of each picture into slice segments is a partitioning. In HEVC, an independent slice segment is defined to be a slice segment for which the values of the syntax elements of the slice segment header are not inferred from the values for a preceding slice segment, and a dependent slice segment is defined to be a slice segment for which the values of some syntax elements of the slice segment header are inferred from the values for the preceding independent slice segment in decoding order. In HEVC, a slice header is defined to be the slice segment header of the independent slice segment that is a current slice segment or is the independent slice segment that precedes a current dependent slice segment, and a slice segment header is defined to be a part of a coded slice segment including the data elements pertaining to the first or all coding tree units represented in the slice segment. The CUs are scanned in the raster scan order of LCUs within tiles or within a picture, when tiles are not in use. Within an LCU, the CUs have a specific scan order.

An intra-coded slice (also called I slice) is a slice that only includes intra-coded blocks. The syntax of an I slice may exclude syntax elements that are related to inter prediction. An inter-coded slice is such where blocks can be intra- or inter-coded. Inter-coded slices may further be categorized into P and B slices, where P slices are such that blocks may be intra-coded or inter-coded but only using uni-prediction, and blocks in B slices may be intra-coded or inter-coded with uni- or bi-prediction.

The decoder reconstructs the output video by applying prediction means similar to the encoder to form a predicted representation of the pixel blocks (using the motion or spatial information created by the encoder and stored in the compressed representation) and prediction error decoding (inverse operation of the prediction error coding recovering the quantized prediction error signal in the spatial pixel domain). After applying prediction and prediction error decoding means, the decoder sums up the prediction and prediction error signals (pixel values) to form the output video frame. The decoder (and encoder) can also apply additional filtering means to improve the quality of the output video before passing it for display and/or storing it as prediction reference for the forthcoming frames in the video sequence.

The filtering may for example include one more of the following: deblocking, sample adaptive offset (SAO), and/or adaptive loop filtering (ALF). H.264/AVC includes a deblocking, whereas HEVC includes both deblocking and SAO.

In video codecs, the motion information may be indicated with motion vectors associated with each motion compensated image block, such as a prediction unit. Each of these motion vectors represents the displacement of the image block in the picture to be coded (in the encoder side) or decoded (in the decoder side) and the prediction source block in one of the previously coded or decoded pictures. In order to represent motion vectors efficiently, those are typically coded differentially with respect to block specific predicted motion vectors.

In video codecs, the predicted motion vectors may be created in a predefined way, for example calculating the median of the encoded or decoded motion vectors of the adjacent blocks. Another way to create motion vector predictions is to generate a list of candidate predictions from adjacent blocks and/or co-located blocks in temporal reference pictures and signaling the chosen candidate as the motion vector predictor.

In addition to predicting the motion vector values, it can be predicted which reference picture(s) are used for motion-compensated prediction, and this prediction information may be represented, for example, by a reference index of previously coded/decoded picture. The reference index is typically predicted from adjacent blocks and/or co-located blocks in temporal reference picture. Moreover, high efficiency video codecs may employ an additional motion information coding/decoding mechanism, often called merging/merge mode, where all the motion field information, which includes motion vector and corresponding reference picture index for each available reference picture list, is predicted and used without any modification/correction. Similarly, predicting the motion field information is carried out using the motion field information of adjacent blocks and/or co-located blocks in temporal reference pictures, and the used motion field information is signaled among a list of motion field candidate list filled with motion field information of available adjacent/co-located blocks.

In video codecs, the prediction residual after motion compensation may be first transformed with a transform kernel (like DCT) and then coded. The reason for this is that, often, there still exists some correlation among the residual, and transform can in many cases help reduce this correlation and provide more efficient coding.

Video encoders may utilize Lagrangian cost functions to find optimal coding modes (e.g. the desired coding mode for a block and associated motion vectors). This kind of cost function uses a weighting factor λ to tie together the (exact or estimated) image distortion due to lossy coding methods and the (exact or estimated) amount of information that is required to represent the pixel values in an image area:

$$C = D + λ R , \qquad ( 1 )$$

where C is the Lagrangian cost to be minimized, D is the image distortion (e.g. Mean Squared Error) with the mode and motion vectors considered, and R the number of bits needed to represent the required data to reconstruct the image block in the decoder (including the amount of data to represent the candidate motion vectors).

Video coding standards and specifications may allow encoders to divide a coded picture to coded slices or alike. In-picture prediction is typically disabled across slice boundaries. Thus, slices can be regarded as a way to split a coded picture to independently decodable pieces. In H.264/AVC and HEVC, in-picture prediction may be disabled across slice boundaries. Thus, slices can be regarded as a way to split a coded picture into independently decodable pieces, and slices are therefore often regarded as elementary units for transmission. In many cases, encoders may indicate in the bitstream which types of in-picture prediction are turned off across slice boundaries, and the decoder operation takes this information into account, for example when concluding which prediction sources are available. For example, samples from a neighboring CU may be regarded as unavailable for intra prediction, when the neighboring CU resides in a different slice.

An elementary unit for the output of an H.264/AVC or HEVC encoder and the input of an H.264/AVC or HEVC decoder, respectively, is a network abstraction layer (NAL) unit. For transport over packet-oriented networks or storage into structured files, NAL units may be encapsulated into packets or similar structures. A bytestream format has been specified in H.264/AVC and HEVC for transmission or storage environments that do not provide framing structures. The bytestream format separates NAL units from each other by attaching a start code in front of each NAL unit. To avoid false detection of NAL unit boundaries, encoders run a byte-oriented start code emulation prevention algorithm, which adds an emulation prevention byte to the NAL unit payload when a start code would have occurred otherwise. In order to enable straightforward gateway operation between packet- and stream-oriented systems, start code emulation prevention may always be performed, regardless of whether the bytestream format is in use or not. A NAL unit (NALU) may be defined as a syntax structure including an indication of the type of data to follow and bytes including that data in the form of an RBSP interspersed as necessary with emulation prevention bytes. A raw byte sequence payload (RBSP) may be defined as a syntax structure including an integer number of bytes that is encapsulated in a NAL unit. An RBSP is either empty or has the form of a string of data bits including syntax elements followed by an RBSP stop bit and followed by zero or more subsequent bits equal to 0.

NAL units include a header and payload. In H.264/AVC and HEVC, the NAL unit header indicates the type of the NAL unit.

In HEVC, a two-byte NAL unit header is used for all specified NAL unit types. The NAL unit header includes one reserved bit, a six-bit NAL unit type indication, a three-bit nuh_temporal_id_plus1 indication for temporal level (may be required to be greater than or equal to 1) and a six-bit nuh_layer_id syntax element. The temporal_id_plus1 syntax element may be regarded as a temporal identifier for the NAL unit, and a zero-based TemporalId variable may be derived as follows: TemporalId=temporal_id_plus1−1. The abbreviation TID may be used interchangeably with the TemporalId variable. TemporalId equal to 0 corresponds to the lowest temporal level. The value of temporal_id_plus1 is required to be non-zero in order to avoid start code emulation involving the two NAL unit header bytes. The bitstream created by excluding all VCL NAL units having a TemporalId greater than or equal to a selected value and including all other VCL NAL units remains conforming. Consequently, a picture having TemporalId equal to tid_value does not use any picture having a TemporalId greater than tid_value as inter prediction reference. A sub-layer or a temporal sub-layer may be defined to be a temporal scalable layer (or a temporal layer, TL) of a temporal scalable bitstream, including VCL NAL units with a particular value of the TemporalId variable and the associated non-VCL NAL units. The nuh_layer_id can be understood as a scalability layer identifier.

NAL units can be categorized into Video Coding Layer (VCL) NAL units and non-VCL NAL units. VCL NAL units may be coded slice NAL units. In HEVC, VCL NAL units include syntax elements representing one or more CU.

In HEVC, abbreviations for picture types may be defined as follows: trailing (TRAIL) picture, temporal sub-layer access (TSA), step-wise temporal sub-layer access (STSA), random access decodable leading (RADL) picture, random access skipped leading (RASL) picture, broken link access (BLA) picture, instantaneous decoding refresh (IDR) picture, clean random access (CRA) picture.

A random access point (RAP) picture, which may also be referred to as an intra random access point (IRAP) picture in an independent layer, includes only intra-coded slices. An IRAP picture belonging to a predicted layer may include P, B, and I slices, cannot use inter prediction from other pictures in the same predicted layer, and may use inter-layer prediction from its direct reference layers. In the present version of HEVC, an IRAP picture may be a BLA picture, a CRA picture or an IDR picture. The first picture in a bitstream including a base layer is an IRAP picture at the base layer. Provided the necessary parameter sets are available when they need to be activated, an IRAP picture at an independent layer and all subsequent non-RASL pictures at the independent layer in decoding order can be correctly decoded without performing the decoding process of any pictures that precede the IRAP picture in decoding order. The IRAP picture belonging to a predicted layer and all subsequent non-RASL pictures in decoding order within the same predicted layer can be correctly decoded without performing the decoding process of any pictures of the same predicted layer that precede the IRAP picture in decoding order, when the necessary parameter sets are available when they need to be activated and when the decoding of each direct reference layer of the predicted layer has been initialized. There may be pictures in a bitstream that include only intra-coded slices that are not IRAP pictures.

A non-VCL NAL unit may be, for example, one of the following types: a sequence parameter set, a picture parameter set, a supplemental enhancement information (SEI) NAL unit, an access unit delimiter, an end of sequence NAL unit, an end of bitstream NAL unit, or a filler data NAL unit. Parameter sets may be needed for the reconstruction of decoded pictures, whereas many of the other non-VCL NAL units are not necessary for the reconstruction of decoded sample values.

Parameters that remain unchanged through a coded video sequence may be included in a sequence parameter set. In addition to the parameters that may be needed by the decoding process, the sequence parameter set may optionally include video usability information (VUI), which includes parameters that may be important for buffering, picture output timing, rendering, and resource reservation. In HEVC, a sequence parameter set RBSP includes parameters that can be referred to by one or more picture parameter set RBSPs or one or more SEI NAL units including a buffering period SEI message. A picture parameter set includes such parameters that are likely to be unchanged in several coded pictures. A picture parameter set RBSP may include parameters that can be referred to by the coded slice NAL units of one or more coded pictures.

In HEVC, a video parameter set (VPS) may be defined as a syntax structure including syntax elements that apply to zero or more entire coded video sequences as determined by the content of a syntax element, found in the SPS, referred to by a syntax element found in the PPS, referred to by a syntax element found in each slice segment header.

A video parameter set RBSP may include parameters that can be referred to by one or more sequence parameter set RBSPs.

The relationship and hierarchy between video parameter set (VPS), sequence parameter set (SPS), and picture parameter set (PPS) may be described as follows. VPS resides one level above SPS in the parameter set hierarchy and in the context of scalability and/or 3D video. VPS may include parameters that are common for all slices across all (scalability or view) layers in the entire coded video sequence. SPS includes the parameters that are common for all slices in a particular (scalability or view) layer in the entire coded video sequence, and may be shared by multiple (scalability or view) layers. PPS includes the parameters that are common for all slices in a particular layer representation (the representation of one scalability or view layer in one access unit) and are likely to be shared by all slices in multiple layer representations.

VPS may provide information about the dependency relationships of the layers in a bitstream, as well as many other information that are applicable to all slices across all (scalability or view) layers in the entire coded video sequence. VPS may be considered to comprise two parts, the base VPS and a VPS extension, where the VPS extension may be optionally present.

Out-of-band transmission, signaling or storage can additionally or alternatively be used for purposes other than tolerance against transmission errors, such as ease of access or session negotiation. For example, a sample entry of a track in a file conforming to the ISO Base Media File Format may comprise parameter sets, while the coded data in the bitstream is stored elsewhere in the file or in another file. The phrase along the bitstream (e.g. indicating along the bitstream) may be used in claims and described embodiments to refer to out-of-band transmission, signaling, or storage in a manner that the out-of-band data is associated with the bitstream. The phrase decoding along the bitstream, or alike, may refer to decoding the referred out-of-band data (which may be obtained from out-of-band transmission, signaling, or storage) that is associated with the bitstream.

A SEI NAL unit may include one or more SEI messages, which are not required for the decoding of output pictures but may assist in related processes, such as picture output timing, rendering, error detection, error concealment, and resource reservation. Several SEI messages are specified in H.264/AVC and HEVC, and the user data SEI messages enable organizations and companies to specify SEI messages for their own use. H.264/AVC and HEVC include the syntax and semantics for the specified SEI messages, but no process for handling the messages in the recipient is defined. Consequently, encoders are required to follow the H.264/AVC standard or the HEVC standard when they create SEI messages, and decoders conforming to the H.264/AVC standard or the HEVC standard, respectively, are not required to process SEI messages for output order conformance. One of the reasons to include the syntax and semantics of SEI messages in H.264/AVC and HEVC is to allow different system specifications to interpret the supplemental information identically and hence interoperate. It is intended that system specifications can require the use of particular SEI messages both in the encoding end and in the decoding end, and additionally the process for handling particular SEI messages in the recipient can be specified.

In HEVC, there are two types of SEI NAL units, namely the suffix SEI NAL unit and the prefix SEI NAL unit, having a different nal_unit_type value from each other. The SEI message(s) contained in a suffix SEI NAL unit are associated with the VCL NAL unit preceding, in decoding order, the suffix SEI NAL unit. The SEI message(s) contained in a prefix SEI NAL unit are associated with the VCL NAL unit following, in decoding order, the prefix SEI NAL unit.

A coded picture is a coded representation of a picture. In HEVC, a coded picture may be defined as a coded representation of a picture including all coding tree units of the picture. In HEVC, an access unit (AU) may be defined as a set of NAL units that are associated with each other according to a specified classification rule, are consecutive in decoding order, and include at most one picture with any specific value of nuh_layer_id. In addition to including the VCL NAL units of the coded picture, an access unit may also include non-VCL NAL units. Said specified classification rule may for example associate pictures with the same output time or picture output count value into the same access unit.

A bitstream may be defined as a sequence of bits, in the form of a NAL unit stream or a byte stream, that forms the representation of coded pictures and associated data forming one or more coded video sequences. A first bitstream may be followed by a second bitstream in the same logical channel, such as in the same file or in the same connection of a communication protocol. An elementary stream (in the context of video coding) may be defined as a sequence of one or more bitstreams. The end of the first bitstream may be indicated by a specific NAL unit, which may be referred to as the end of bitstream (EOB) NAL unit and which is the last NAL unit of the bitstream. In HEVC and its current draft extensions, the EOB NAL unit is required to have nuh_layer_id equal to 0.

A coded video sequence may be defined as such a sequence of coded pictures in decoding order that is independently decodable and is followed by another coded video sequence or the end of the bitstream or an end of sequence NAL unit.

In HEVC, a coded video sequence may additionally or alternatively (to the specification above) be specified to end when a specific NAL unit, which may be referred to as an end of sequence (EOS) NAL unit, appears in the bitstream and has nuh_layer_id equal to 0.

A group of pictures (GOP) and its characteristics may be defined as follows. A GOP can be decoded regardless of whether any previous pictures were decoded. An open GOP is such a group of pictures in which pictures preceding the initial intra picture in output order might not be correctly decodable when the decoding starts from the initial intra picture of the open GOP. In other words, pictures of an open GOP may refer (in inter prediction) to pictures belonging to a previous GOP. An HEVC decoder can recognize an intra picture starting an open GOP, because a specific NAL unit type, CRA NAL unit type, may be used for its coded slices.

A closed GOP is such a group of pictures in which all pictures can be correctly decoded when the decoding starts from the initial intra picture of the closed GOP. In other words, no picture in a closed GOP refers to any pictures in previous GOPs. In H.264/AVC and HEVC, a closed GOP may start from an IDR picture. In HEVC, a closed GOP may also start from a BLA_W_RADL or a BLA_N_LP picture. An open GOP coding structure is potentially more efficient in the compression compared to a closed GOP coding structure, due to a larger flexibility in selection of reference pictures.

A structure of pictures (SOP) may be defined as one or more coded pictures consecutive in decoding order, in which the first coded picture in decoding order is a reference picture at the lowest temporal sub-layer and no coded picture except, potentially, the first coded picture in decoding order is a RAP picture. All pictures in the previous SOP precede in decoding order all pictures in the current SOP, and all pictures in the next SOP succeed in decoding order all pictures in the current SOP. A SOP may represent a hierarchical and repetitive inter prediction structure. The term group of pictures (GOP) may sometimes be used interchangeably with the term SOP, and having the same semantics as the semantics of SOP.

A decoded picture buffer (DPB) may be used in the encoder and/or in the decoder. There are two reasons to buffer decoded pictures: for references in inter prediction, and for reordering decoded pictures into output order. As H.264/AVC and HEVC provide a great deal of flexibility for both reference picture marking and output reordering, separate buffers for reference picture buffering and output picture buffering may waste memory resources. Hence, the DPB may include a unified decoded picture buffering process for reference pictures and output reordering. A decoded picture may be removed from the DPB when it is no longer used as a reference and is not needed for output.

In many coding modes of H.264/AVC and HEVC, the reference picture for inter prediction is indicated with an index to a reference picture list. The index may be coded with variable length coding, which usually causes a smaller index to have a shorter value for the corresponding syntax element. In H.264/AVC and HEVC, two reference picture lists (reference picture list 0 and reference picture list 1) are generated for each bi-predictive (B) slice, and one reference picture list (reference picture list 0) is formed for each inter-coded (P) slice.

A reference picture list, such as the reference picture list 0 and the reference picture list 1, may be constructed in two steps. First, an initial reference picture list is generated. The initial reference picture list may be generated, for example, on the basis of frame_num, picture order count (POC), temporal_id, or information on the prediction hierarchy such as a GOP structure, or any combination thereof. Second, the initial reference picture list may be reordered by reference picture list reordering (RPLR) syntax, also known as reference picture list modification syntax structure, which may be contained in slice headers. The initial reference picture lists may be modified through the reference picture list modification syntax structure, where pictures in the initial reference picture lists may be identified through an entry index to the list.

Many coding standards, including H.264/AVC and HEVC, may have decoding process to derive a reference picture index to a reference picture list, which may be used to indicate which one of the multiple reference pictures is used for inter prediction for a particular block. A reference picture index may be coded by an encoder into the bitstream in some inter coding modes, or it may be derived (by an encoder and a decoder), for example using neighboring blocks, in some other inter coding modes.

Several candidate motion vectors may be derived for a single prediction unit. For example, motion vector prediction HEVC includes two motion vector prediction schemes, namely the advanced motion vector prediction (AMVP) and the merge mode. In the AMVP or the merge mode, a list of motion vector candidates is derived for a PU. There are two kinds of candidates: spatial candidates and temporal candidates, where temporal candidates may also be referred to as temporal motion vector prediction (TMVP) candidates.

A candidate list derivation may be performed, for example, as follows; it should be understood that other possibilities may exist for candidate list derivation. When the occupancy of the candidate list is not at a maximum, the spatial candidates are included in the candidate list first when they are available and not already in the candidate list. After that, when occupancy of the candidate list is not yet at the maximum, a temporal candidate is included in the candidate list. When the number of candidates still does not reach the maximum allowed number, the combined bi-predictive candidates (for B slices) and a zero motion vector are added in. After the candidate list has been constructed, the encoder decides the final motion information from candidates, for example based on a rate-distortion optimization (RDO) decision, and encodes the index of the selected candidate into the bitstream. Likewise, the decoder decodes the index of the selected candidate from the bitstream, constructs the candidate list, and uses the decoded index to select a motion vector predictor from the candidate list.

A motion vector anchor position may be defined as a position (e.g. horizontal and vertical coordinates) within a picture area relative to which the motion vector is applied. A horizontal offset and a vertical offset for the anchor position may be given in the slice header, slice parameter set, tile header, tile parameter set, or the like.

An example encoding method taking advantage of a motion vector anchor position may comprise: encoding an input picture into a coded constituent picture; reconstructing, as a part of said encoding, a decoded constituent picture corresponding to the coded constituent picture; encoding a spatial region into a coded tile, the encoding comprising: determining a horizontal offset and a vertical offset indicative of a region-wise anchor position of the spatial region within the decoded constituent picture; encoding the horizontal offset and the vertical offset; determining that a prediction unit at position of a first horizontal coordinate and a first vertical coordinate of the coded tile is predicted relative to the region-wise anchor position, wherein the first horizontal coordinate and the first vertical coordinate are horizontal and vertical coordinates, respectively, within the spatial region; indicating that the prediction unit is predicted relative to a prediction-unit anchor position that is relative to the region-wise anchor position; deriving a prediction-unit anchor position equal to sum of the first horizontal coordinate and the horizontal offset, and the first vertical coordinate and the vertical offset, respectively; determining a motion vector for the prediction unit; and applying the motion vector relative to the prediction-unit anchor position to obtain a prediction block.

An example decoding method wherein a motion vector anchor position is used may comprise: decoding a coded tile into a decoded tile, the decoding comprising: decoding a horizontal offset and a vertical offset; decoding an indication that a prediction unit at position of a first horizontal coordinate and a first vertical coordinate of the coded tile is predicted relative to a prediction-unit anchor position that is relative to the horizontal and vertical offset; deriving a prediction-unit anchor position equal to sum of the first horizontal coordinate and the horizontal offset, and the first vertical coordinate and the vertical offset, respectively; determining a motion vector for the prediction unit; and applying the motion vector relative to the prediction-unit anchor position to obtain a prediction block.

Features as described herein may generally relate to scalable video coding. Scalable video coding may refer to a coding structure where one bitstream can include multiple representations of the content, for example, at different bitrates, resolutions or frame rates. In these cases the receiver can extract the desired representation depending on its characteristics (e.g. resolution that matches best the display device). Alternatively, a server or a network element can extract the portions of the bitstream to be transmitted to the receiver depending on, for example, the network characteristics or processing capabilities of the receiver. A meaningful decoded representation can be produced by decoding only certain parts of a scalable bit stream. A scalable bitstream may include a “base layer” providing the lowest quality video available, and one or more enhancement layers that enhance the video quality when received and decoded together with the lower layers. In order to improve coding efficiency for the enhancement layers, the coded representation of that layer typically depends on the lower layers. For example, the motion and mode information of the enhancement layer can be predicted from lower layers. Similarly, the pixel data of the lower layers can be used to create prediction for the enhancement layer.

In some scalable video coding schemes, a video signal can be encoded into a base layer and one or more enhancement layers. An enhancement layer may enhance, for example, the temporal resolution (e.g., the frame rate), the spatial resolution, or simply the quality of the video content represented by another layer or part thereof. Each layer, together with all its dependent layers, is one representation of the video signal, for example, at a certain spatial resolution, temporal resolution and quality level. In the present disclosure, a scalable layer together with all of its dependent layers is referred to as a “scalable layer representation”. The portion of a scalable bitstream corresponding to a scalable layer representation can be extracted and decoded to produce a representation of the original signal at certain fidelity.

Scalability modes or scalability dimensions may include but are not limited to the following:
Quality scalability: base layer pictures are coded at a lower quality than enhancement layer pictures, which may be achieved for example using a greater quantization parameter value (e.g., a greater quantization step size for transform coefficient quantization) in the base layer than in the enhancement layer. Quality scalability may be further categorized into fine-grain or fine-granularity scalability (FGS), medium-grain or medium-granularity scalability (MGS), and/or coarse-grain or coarse-granularity scalability (CGS), as described below.
Spatial scalability: base layer pictures are coded at a lower resolution (e.g., have fewer samples) than enhancement layer pictures. Spatial scalability and quality scalability, particularly its coarse-grain scalability type, may sometimes be considered the same type of scalability.
View scalability, which may also be referred to as multiview coding. The base layer represents a first view, whereas an enhancement layer represents a second view. A view may be defined as a sequence of pictures representing one camera or viewpoint. It may be considered that in stereoscopic or two-view video, one video sequence or view is presented for the left eye while a parallel view is presented for the right eye.
Depth scalability, which may also be referred to as depth-enhanced coding. A layer or some layers of a bitstream may represent texture view(s), while other layer or layers may represent depth view(s).

It should be understood that many of the scalability types may be combined and applied together.

The term “layer” may be used in the context of any type of scalability, including view scalability and depth enhancements. An enhancement layer may refer to any type of an enhancement, such as SNR, spatial, multiview, and/or depth enhancement. A base layer may refer to any type of a base video sequence, such as a base view, a base layer for SNR/spatial scalability, or a texture base view for depth-enhanced video coding.

A sender, a gateway, a client, or another entity may select the transmitted layers and/or sub-layers of a scalable video bitstream. The terms layer extraction, extraction of layers, or layer down-switching may refer to transmitting fewer layers than what is available in the bitstream received by the sender, the gateway, the client, or another entity. Layer up-switching may refer to transmitting additional layer(s) compared to those transmitted prior to the layer up-switching by the sender, the gateway, the client, or another entity, e.g., restarting the transmission of one or more layers whose transmission was ceased earlier in layer down-switching. Similarly to layer down-switching and/or up-switching, the sender, the gateway, the client, or another entity may perform down- and/or up-switching of temporal sub-layers. The sender, the gateway, the client, or another entity may also perform both layer and sub-layer down-switching and/or up-switching. Layer and sub-layer down-switching and/or up-switching may be carried out in the same access unit or alike (e.g., virtually simultaneously) or may be carried out in different access units or alike (e.g., virtually at distinct times).

A scalable video encoder for quality scalability (also known as Signal-to-Noise or SNR) and/or spatial scalability may be implemented as follows. For a base layer, a conventional non-scalable video encoder and decoder may be used. The reconstructed/decoded pictures of the base layer are included in the reference picture buffer and/or reference picture lists for an enhancement layer. In case of spatial scalability, the reconstructed/decoded base-layer picture may be upsampled prior to its insertion into the reference picture lists for an enhancement-layer picture. The base layer decoded pictures may be inserted into a reference picture list(s) for coding/decoding of an enhancement layer picture, similarly to the decoded reference pictures of the enhancement layer. Consequently, the encoder may choose a base-layer reference picture as an inter prediction reference and indicate its use with a reference picture index in the coded bitstream. The decoder decodes from the bitstream, for example from a reference picture index, that a base-layer picture is used as an inter prediction reference for the enhancement layer. When a decoded base-layer picture is used as the prediction reference for an enhancement layer, it is referred to as an inter-layer reference picture.

While the previous paragraph described a scalable video codec with two scalability layers with an enhancement layer and a base layer, it needs to be understood that the description can be generalized to any two layers in a scalability hierarchy with more than two layers. In this case, a second enhancement layer may depend on a first enhancement layer in encoding and/or decoding processes, and the first enhancement layer may therefore be regarded as the base layer for the encoding and/or decoding of the second enhancement layer. Furthermore, it needs to be understood that there may be inter-layer reference pictures from more than one layer in a reference picture buffer or reference picture lists of an enhancement layer, and each of these inter-layer reference pictures may be considered to reside in a base layer or a reference layer for the enhancement layer being encoded and/or decoded. Furthermore, it needs to be understood that other types of inter-layer processing than reference-layer picture upsampling may take place instead or additionally. For example, the bit-depth of the samples of the reference-layer picture may be converted to the bit-depth of the enhancement layer and/or the sample values may undergo a mapping from the color space of the reference layer to the color space of the enhancement layer.

A scalable video coding and/or decoding scheme may use multi-loop coding and/or decoding, which may be characterized as follows. In the encoding/decoding, a base layer picture may be reconstructed/decoded to be used as a motion-compensation reference picture for subsequent pictures, in coding/decoding order, within the same layer or as a reference for inter-layer (or inter-view or inter-component) prediction. The reconstructed/decoded base layer picture may be stored in the DPB. An enhancement layer picture may likewise be reconstructed/decoded to be used as a motion-compensation reference picture for subsequent pictures, in coding/decoding order, within the same layer or as reference for inter-layer (or inter-view or inter-component) prediction for higher enhancement layers, when any. In addition to reconstructed/decoded sample values, syntax element values of the base/reference layer or variables derived from the syntax element values of the base/reference layer may be used in the inter-layer/inter-component/inter-view prediction.

Inter-layer prediction may be defined as prediction in a manner that is dependent on data elements (e.g. sample values or motion vectors) of reference pictures from a different layer than the layer of the current picture (being encoded or decoded). Many types of inter-layer prediction exist and may be applied in a scalable video encoder/decoder. The available types of inter-layer prediction may, for example, depend on the coding profile according to which the bitstream or a particular layer within the bitstream is being encoded or, when decoding, the coding profile that the bitstream or a particular layer within the bitstream is indicated to conform to. Alternatively or additionally, the available types of inter-layer prediction may depend on the types of scalability or the type of a scalable codec or video coding standard amendment (e.g. SHVC, MV-HEVC, or 3D-HEVC) being used.

A direct reference layer may be defined as a layer that may be used for inter-layer prediction of another layer for which the layer is the direct reference layer. A direct predicted layer may be defined as a layer for which another layer is a direct reference layer. An indirect reference layer may be defined as a layer that is not a direct reference layer of a second layer, but is a direct reference layer of a third layer that is a direct reference layer or indirect reference layer of a direct reference layer of the second layer for which the layer is the indirect reference layer. An indirect predicted layer may be defined as a layer for which another layer is an indirect reference layer. An independent layer may be defined as a layer that does not have direct reference layers. In other words, an independent layer is not predicted using inter-layer prediction. A non-base layer may be defined as any other layer than the base layer, and the base layer may be defined as the lowest layer in the bitstream. An independent non-base layer may be defined as a layer that is both an independent layer and a non-base layer.

Similarly to MVC, in MV-HEVC, inter-view reference pictures can be included in the reference picture list(s) of the current picture being coded or decoded. SHVC uses multi-loop decoding operation (unlike the SVC extension of H.264/AVC). SHVC may be considered to use a reference index based approach, e.g., an inter-layer reference picture can be included in one or more reference picture lists of the current picture being coded or decoded (as described above).

For the enhancement layer coding, the concepts and coding tools of HEVC base layer may be used in SHVC, MV-HEVC, and/or alike. However, the additional inter-layer prediction tools, which employ already coded data (including reconstructed picture samples and motion parameters a.k.a motion information) in reference layer for efficiently coding an enhancement layer, may be integrated to SHVC, MV-HEVC, and/or alike codec.

Video coding specifications may include a set of constraints for associating data units (e.g. NAL units in H.264/AVC or HEVC) into access units. These constraints may be used to conclude access unit boundaries from a sequence of NAL units. For example, the following is specified in the HEVC standard:
An access unit includes one coded picture with nuh_layer_id equal to 0, zero or more VCL NAL units with nuh_layer_id greater than 0 and zero or more non-VCL NAL units.
Let firstBlPicNalUnit be the first VCL NAL unit of a coded picture with nuh_layer_id equal to 0. The first of any of the following NAL units preceding firstBlPicNalUnit and succeeding the last VCL NAL unit preceding firstBlPicNalUnit, when any, specifies the start of a new access unit: access unit delimiter NAL unit with nuh_layer_id equal to 0 (when present); VPS NAL unit with nuh_layer_id equal to 0 (when present); SPS NAL unit with nuh_layer_id equal to 0 (when present); PPS NAL unit with nuh_layer_id equal to 0 (when present); Prefix SEI NAL unit with nuh_layer_id equal to 0 (when present); NAL units with nal_unit_type in the range of RSV_NVCL41 . . . RSV_NVCL44 with nuh_layer_id equal to 0 (when present); NAL units with nal_unit_type in the range of UNSPEC48 . . . UNSPEC55 with nuh_layer_id equal to 0 (when present).

The first NAL unit preceding firstBlPicNalUnit and succeeding the last VCL NAL unit preceding firstBlPicNalUnit, when any, can only be one of the above-listed NAL units. When there is none of the above NAL units preceding firstBlPicNalUnit and succeeding the last VCL NAL preceding firstBlPicNalUnit, when any, firstBlPicNalUnit starts a new access unit.

Access unit boundary detection may be based on, but may not be limited to, one or more of the following:
Detecting that a VCL NAL unit of a base-layer picture is the first VCL NAL unit of an access unit, for example on the basis that: the VCL NAL unit includes a block address or alike that is the first block of the picture in decoding order; and/or the picture order count, picture number, or similar decoding or output order or timing indicator differs from that of the previous VCL NAL unit(s).
Having detected the first VCL NAL unit of an access unit, concluding based on predefined rules, for example, based on nal_unit_type, which non-VCL NAL units that precede the first VCL NAL unit of an access unit and succeed the last VCL NAL unit of the previous access unit in decoding order belong to the access unit.

The versatile video coding (VVC) includes new coding tools compared to HEVC or H.264/AVC. These coding tools are related to, for example, intra prediction; inter-picture prediction; transform, quantization and coefficients coding; entropy coding; in-loop filter; screen content coding; 360-degree video coding; high-level syntax and parallel processing. Some of these tools are briefly described in the following:
Intra prediction: 67 intra mode with wide angles mode extension; block size and mode dependent 4 tap interpolation filter; position dependent intra prediction combination (PDPC); cross component linear model intra prediction (CCLM); multi-reference line intra prediction; intra sub-partitions; weighted intra prediction with matrix multiplication.
Inter-picture prediction: block motion copy with spatial, temporal, history-based, and pairwise average merging candidates; affine motion inter prediction; sub-block based temporal motion vector prediction; adaptive motion vector resolution; 8×8 block-based motion compression for temporal motion prediction; high precision ( 1/16 pel) motion vector storage and motion compensation with 8-tap interpolation filter for luma component and 4-tap interpolation filter for chroma component; triangular partitions; combined intra and inter prediction; merge with motion vector difference (MVD) (MMVD); symmetrical MVD coding; bi-directional optical flow; decoder side motion vector refinement; bi-prediction with CU-level weight.
Transform, quantization and coefficients coding: multiple primary transform selection with DCT2, DST7 and DCT8; secondary transform for low frequency zone; sub-block transform for inter predicted residual; dependent quantization with max QP increased from 51 to 63; transform coefficient coding with sign data hiding; transform skip residual coding.
Entropy coding: arithmetic coding engine with adaptive double windows probability update.
In loop filter: in-loop reshaping; deblocking filter with strong longer filter; sample adaptive offset; adaptive loop filter.
Screen content coding: current picture referencing with reference region restriction.
360-degree video coding: horizontal wrap-around motion compensation.
High-level syntax and parallel processing: reference picture management with direct reference picture list signaling; tile groups with rectangular shape tile groups.

In VVC, each picture may be partitioned into coding tree units (CTUs) similar to HEVC. A CTU may be split into smaller CUs using quaternary tree structure. Each CU may be partitioned using quad-tree and nested multi-type tree, including ternary and binary split. There are specific rules to infer partitioning in picture boundaries. The redundant split patterns are disallowed in nested multi-type partitioning.

In some video coding schemes, such as HEVC and VVC, a picture is divided into one or more tile rows and one or more tile columns. The partitioning of a picture to tiles forms a tile grid that may be characterized by a list of tile column widths and a list of tile row heights. A tile may be required to include an integer number of elementary coding blocks, such as CTUs in HEVC and VVC. Consequently, tile column widths and tile row heights may be expressed in the units of elementary coding blocks, such as CTUs in HEVC and VVC.

A tile may be defined as a sequence of elementary coding blocks, such as CTUs in HEVC and VVC, that covers one “cell” in the tile grid (e.g., a rectangular region of a picture). Elementary coding blocks, such as CTUs, may be ordered in the bitstream in raster scan order within a tile.

Some video coding schemes may allow further subdivision of a tile into one or more bricks, each including a number of CTU rows within the tile. A tile that is not partitioned into multiple bricks may also be referred to as a brick. However, a brick that is a true subset of a tile is not referred to as a tile.

In some video coding schemes, such as H.264/AVC, HEVC and VVC, a coded picture may be partitioned into one or more slices. A slice may be decodable independently of other slices of a picture and hence a slice may be considered as a preferred unit for transmission. In some video coding schemes, such as H.264/AVC, HEVC, and VVC, a video coding layer (VCL) NAL unit includes exactly one slice.

A slice may comprise an integer number of elementary coding blocks, such as CTUs in HEVC or VVC.

In some video coding schemes, such as VVC, a slice includes an integer number of tiles of a picture or an integer number of CTU rows of a tile.

In some video coding schemes, two modes of slices may be supported, namely the raster-scan slice mode and the rectangular slice mode. In the raster-scan slice mode, a slice includes a sequence of tiles in a tile raster scan of a picture. In the rectangular slice mode, a slice includes an integer number of tiles of a picture or an integer number of CTU rows of a tile that collectively form a rectangular region of the picture.

A non-VCL NAL unit may be, for example, one of the following types: a video parameter set (VPS), a sequence parameter set (SPS), a picture parameter set (PPS), an adaptation parameter set (APS), a supplemental enhancement information (SEI) NAL unit, a picture header (PH) NAL unit, an end of sequence NAL unit, an end of bitstream NAL unit, or a filler data NAL unit. Some non-VCL NAL units, such as parameter sets and picture headers, may be needed for the reconstruction of decoded pictures, whereas many of the other non-VCL NAL units might not be necessary for the reconstruction of decoded sample values.

Some coding formats specify parameter sets that may carry parameter values needed for the decoding or reconstruction of decoded pictures. Some examples of different types of parameter sets are now briefly described. A video parameter set (VPS) may include parameters that are common across multiple layers in a coded video sequence or describe relations between layers. Parameters that remain unchanged through a coded video sequence (in a single-layer bitstream) or in a coded layer video sequence may be included in a sequence parameter set (SPS). In addition to the parameters that may be needed by the decoding process, the sequence parameter set may optionally include video usability information (VUI), which includes parameters that may be important for buffering, picture output timing, rendering, and resource reservation. A picture parameter set (PPS) includes such parameters that are likely to be unchanged in several coded pictures. A picture parameter set may include parameters that can be referred to by the coded image segments of one or more coded pictures. A header parameter set (HPS) has been proposed to include such parameters that may change on a picture basis. In VVC, an Adaptation Parameter Set (APS) may comprise parameters for decoding processes of different types, such as adaptive loop filtering or luma mapping with chroma scaling.

A parameter set may be activated when it is referenced e.g., through its identifier. For example, a header of an image segment, such as a slice header, may include an identifier of the PPS that is activated for decoding the coded picture including the image segment. A PPS may include an identifier of the SPS that is activated, when the PPS is activated. An activation of a parameter set of a particular type may cause the deactivation of the previously active parameter set of the same type.

Instead of or in addition to parameter sets at different hierarchy levels (e.g. sequence and picture), video coding formats may include header syntax structures, such as a sequence header or a picture header. A sequence header may precede any other data of the coded video sequence in the bitstream order. A picture header may precede any coded video data for the picture in the bitstream order.

Video coding specifications may enable the use of supplemental enhancement information (SEI) messages or alike. Some video coding specifications include SEI NAL units, and some video coding specifications include both prefix SEI NAL units and suffix SEI NAL units. A prefix SEI NAL unit can start a picture unit or alike; and a suffix SEI NAL unit can end a picture unit or alike. Hereafter, an SEI NAL unit may equivalently refer to a prefix SEI NAL unit or a suffix SEI NAL unit. An SEI NAL unit includes one or more SEI messages, which are not required for the decoding of output pictures but may assist in related processes, such as picture output timing, postprocessing of decoded pictures, rendering, error detection, error concealment, and resource reservation.

Several SEI messages are specified in H.264/AVC, H.265/HEVC, H.266/VVC, and H.274/VSEI standards, and the user data SEI messages enable organizations and companies to specify SEI messages for specific use. The standards may include the syntax and semantics for the specified SEI messages, but a process for handling the messages in the recipient might not be defined. Consequently, encoders may be required to follow the standard specifying a SEI message when they create SEI message(s), and decoders might not be required to process SEI messages for output order conformance. One of the reasons to include the syntax and semantics of SEI messages in standards is to allow different system specifications to interpret the supplemental information identically and hence interoperate. It is intended that system specifications can require the use of particular SEI messages both in the encoding end and in the decoding end, and additionally the process for handling particular SEI messages in the recipient can be specified.

Features as described herein may generally relate to a bitstream. A bitstream may be defined as a sequence of bits, which may in some coding formats or standards be in the form of a NAL unit stream or a byte stream, that forms the representation of coded pictures and associated data forming one or more coded video sequences. A first bitstream may be followed by a second bitstream in the same logical channel, such as in the same file or in the same connection of a communication protocol. An elementary stream (in the context of video coding) may be defined as a sequence of one or more bitstreams. In some coding formats or standards, the end of the first bitstream may be indicated by a specific NAL unit, which may be referred to as the end of bitstream (EOB) NAL unit and is the last NAL unit of the bitstream.

A coded video sequence (CVS) may be defined as such a sequence of coded pictures in decoding order that is independently decodable and is followed by another coded video sequence or the end of the bitstream.

The subpicture feature of VVC allows for partitioning of the VVC bitstream in a flexible manner as multiple rectangles representing subpictures, where each subpicture comprises one or more slices. In other words, a subpicture may be defined as a rectangular region of one or more slices within a picture, wherein the one or more slices are complete. Consequently, a subpicture includes one or more slices that collectively cover a rectangular region of a picture. The slices of a subpicture may be required to be rectangular slices.

In VVC, the feature of subpictures enables efficient extraction of subpicture(s) from one or more bitstream and merging the extracted subpictures to form another bitstream without excessive penalty in compression efficiency and without modifications of VCL NAL units (e.g., slices).

The use of subpictures in a coded video sequence (CVS), however, requires appropriate configuration of the encoder and other parameters such as SPS/PPS and so on. In VVC, a layout of partitioning of a picture to subpictures may be indicated in and/or decoded from an SPS. A subpicture layout may be defined as a partitioning of a picture to subpictures. In VVC, the SPS syntax indicates the partitioning of a picture to subpictures by providing for each subpicture syntax elements indicative of: the x and y coordinates of the top-left corner of the subpicture, the width of the subpicture, and the height of the subpicture, in CTU units. One or more of the following properties may be indicated (e.g. by an encoder) or decoded (e.g. by a decoder) or inferred (e.g. by an encoder and/or a decoder) for the subpictures collectively or per each subpicture individually: i) whether or not a subpicture is treated like a picture in the decoding process (or equivalently, whether or not subpicture boundaries are treated like picture boundaries in the decoding process); in some cases, this property excludes in-loop filtering operations, which may be separately indicated/decoded/inferred; ii) whether or not in-loop filtering operations are performed across the subpicture boundaries. When a subpicture is treated like a picture in the decoding process, any references to sample locations outside the subpicture boundaries are saturated to be within the subpicture boundaries. This may be regarded being equivalent to padding samples outside subpicture boundaries with the boundary sample values for decoding the subpicture. Consequently, motion vectors may be allowed to cause references outside subpicture boundaries in a subpicture that is extractable.

An independent subpicture (a.k.a. an extractable subpicture) may be defined as a subpicture i) with subpicture boundaries that are treated as picture boundaries and ii) without loop filtering across the subpicture boundaries. A dependent subpicture may be defined as a subpicture that is not an independent subpicture.

In video coding, an isolated region may be defined as a picture region that is allowed to depend only on the corresponding isolated region in reference pictures and does not depend on any other picture regions in the current picture or in the reference pictures. The corresponding isolated region in reference pictures may be, for example, the picture region that collocates with the isolated region in a current picture. A coded isolated region may be decoded without the presence of any picture regions of the same coded picture.

A VVC subpicture with boundaries treated like picture boundaries may be regarded as an isolated region.

A motion-constrained tile set (MCTS) is a set of tiles such that the inter prediction process is constrained in encoding such that no sample value outside the MCTS, and no sample value at a fractional sample position that is derived using one or more sample values outside the motion-constrained tile set, is used for inter prediction of any sample within the motion-constrained tile set. Additionally, the encoding of an MCTS is constrained in a manner that no parameter prediction takes inputs from blocks outside the MCTS. For example, the encoding of an MCTS is constrained in a manner that motion vector candidates are not derived from blocks outside the MCTS. In HEVC, this may be enforced by turning off temporal motion vector prediction of HEVC, or by disallowing the encoder to use the temporal motion vector prediction (TMVP) candidate or any motion vector prediction candidate following the TMVP candidate in a motion vector candidate list for prediction units located directly left of the right tile boundary of the MCTS, except the last one at the bottom right of the MCTS.

In general, an MCTS may be defined to be a tile set that is independent of any sample values and coded data, such as motion vectors, that are outside the MCTS. An MCTS sequence may be defined as a sequence of respective MCTSs in one or more coded video sequences or alike. In some cases, an MCTS may be required to form a rectangular area. It should be understood that, depending on the context, an MCTS may refer to the tile set within a picture or to the respective tile set in a sequence of pictures. The respective tile set may be, but in general need not be, collocated in the sequence of pictures. A motion-constrained tile set may be regarded as an independently coded tile set, since it may be decoded without the other tile sets. An MCTS is an example of an isolated region.

Features as described herein may generally relate to VVC. The VVC has a functionality of subpictures which may be regarded to improve the motion constrained tiles. VVC support for real-time conversational and low latency use cases will be important to fully exploit the functionality and end user benefit with modern networks (e.g. ultra-reliable low-latency communication (ULLRC) 5G networks, over-the-top (OTT) delivery, etc.). VVC encoding and decoding is computationally complex. With increasing computational complexity, the end-user devices consuming the content are heterogeneous, for example devices supporting single decoding instances to devices supporting multiple decoding instances and more sophisticated devices having multiple decoders. Consequently, the system carrying the payload should be able to support a variety of scenarios for scalable deployments. There has been rapid growth in the resolution (e.g. 8K) of the video consumed via consumer electronics (CE) devices (e.g. TVs, mobile devices) which can benefit with the ability to execute multiple parallel decoders. One example use case can be parallel decoding for low latency unicast or multicast delivery of 8K VVC encoded content.

The AV1 codec supports input video signals in the 4:0:0 (monochrome), 4:2:0, 4:2:2, and 4:4:4 formats. The allowed pixel representations are 8, 10, and 12 bit. The AV1 codec operates on pixel blocks. Each pixel block is processed in a predictive-transform coding scheme, where the prediction comes from either intraframe reference pixels, interframe motion compensation, or some combinations of the two. The residuals undergo a 2-D unitary transform to further remove the spatial correlations, and the transform coefficients are quantized. Both the prediction syntax elements and the quantized transform coefficient indexes are then entropy coded using arithmetic coding. There are three optional in-loop postprocessing filter stages to enhance the quality of the reconstructed frame for reference by subsequent coded frames. A normative film grain synthesis unit is also available to improve the perceptual quality of the displayed frames.

The AV1 bitstream is packetized into open bitstream units (OBUs). An ordered sequence of OBUs is fed into the AV1 decoding process, where each OBU comprises a variable length string of bytes. An OBU includes a header and a payload. The header identifies the OBU type and specifies the payload size. The OBU types may include the following.

1) Sequence header includes information that applies to the entire sequence, for example sequence profile (see Section VIII) and whether to enable certain coding tools.

2) Temporal delimiter indicates the frame presentation time stamp. All displayable frames following a temporal delimiter OBU will use this time stamp, until the next temporal delimiter OBU arrives. A temporal delimiter and its subsequent OBUs of the same time stamp are referred to as a temporal unit. In the context of scalable coding, the compression data associated with all representations of a frame at various spatial and fidelity resolutions will be in the same temporal unit.

3) Frame header sets up the coding information for a given frame, including signaling inter or intraframe type, indicating the reference frames, and signaling probability model update method.

4) Tile group includes the tile data associated with a frame. Each tile can be independently decoded. The collective reconstructions form the reconstructed frame after potential loop filtering.

5) Frame includes the frame header and tile data. The frame OBU is largely equivalent to a frame header OBU and a tile group OBU, but allows less overhead cost.

6) Metadata carries information, such as high dynamic range, scalability, and timecode.

7) Tile list includes tile data similar to a tile group OBU. However, each tile here has an additional header that indicates its reference frame index and position in the current frame. This allows the decoder to process a subset of tiles and display the corresponding part of the frame, without the need to fully decode all the tiles in the frame.

In many video communication or transmission systems, transport mechanisms, and multimedia container file formats, there are mechanisms to transmit or store a scalability layer separately from another scalability layer of the same bitstream, e.g. to transmit or store the base layer separately from the enhancement layer(s). It may be considered that layers are stored in or transmitted through separate logical channels. For example in ISOBMFF, the base layer can be stored as a track and each enhancement layer can be stored in another track, which may be linked to the base-layer track using so-called track references.

### Selected Features of the NAL Unit File Format (ISO/IEC 14496-15)

The part-15 of ISO/IEC 14496 specifies the storage format for streams of video that is structured as NAL Units, such as AVC (ISO/IEC 14496-10) and HEVC (ISO/IEC 23008-2) video streams.

A sample according to ISO/IEC 14496-15 comprises one or more length-field-delimited NAL units. The length field may be referred to as NALULength or NALUnitLength. The NAL units in samples do not begin with start codes, but rather the length fields are used for concluding NAL unit boundaries. The scheme of length-field-delimited NAL units may also be referred to as length-prefixed NAL units.

Samples are externally framed and have a size supplied by that external framing. The syntax of a sample is configured via the decoder specific configuration for the elementary stream. An example of the structure of a video sample is given below.

An access unit is made up of a set of NAL units. Each NAL unit is represented with a:
Length: Indicates the length in bytes of the following NAL unit. The length field may be configured to be of 1, 2, or 4 bytes.
NAL Unit: Includes the NAL unit data as specified in the applicable video coding standard.

```
aligned(8) class NALUSample
{
  for (i=0; i<sample_size; ) // to end of the sample
  {
    unsigned int((DecoderConfigurationRecord.LengthSizeMinusOne+1)*8)
      NALUnitLength;
    bit(NALUnitLength * 8) NALUnit;
    i += (DecoderConfigurationRecord.LengthSizeMinusOne+1) +
NALUnitLength;
  }
}
```

### Semantics

DecoderConfigurationRecord indicates the record in the matching sample entry (e.g., AVCDecoderConfigurationRecord in the case of AVC).

NALUnitLength indicates the size of a NAL unit measured in bytes. The length field includes the size of both the NAL header and the NAL unit payload but does not include the length field itself.

NALUnit includes a single NAL unit. The syntax of a NAL unit is defined in the appropriate specification (e.g. ISO/IEC 14496-10) and includes both the one byte NAL header and the variable length encapsulated byte stream payload.

An HEVC visual sample entry shall include an HEVC Configuration Box, this includes an HEVCDecoderConfigurationRecord.

An optional BitRateBox may be present in the HEVC visual sample entry to signal the bit rate information of the HEVC video stream. Extension descriptors that should be inserted into the Elementary Stream Descriptor, when used in MPEG-4, may also be present.

Multiple sample entries may be used, as permitted by ISO/IEC 14496-12, to indicate sections of video that use different configurations or parameter sets.

When the sample entry name is ‘hvc1’ or ‘hev1’, the stream to which this sample entry applies shall be a compliant and HEVC stream as viewed by an HEVC decoder operating under the configuration (including profile, tier, and level) given in the HEVCConfigurationBox.

When the sample entry name is ‘hvc1’, the default and mandatory value of array_completeness is 1 for arrays of all types of parameter sets, and 0 for all other arrays. When the sample entry name is ‘hev1’, the default value of array_completeness is 0 for all arrays.

### Syntax

```
class HEVCConfigurationBox extends Box(‘hvcC’) {
  HEVCDecoderConfigurationRecord( ) HEVCConfig;
}
class HEVCSampleEntry( ) extends VisualSampleEntry
(‘hvc1’ or ‘hev1’){
  HEVCConfigurationBox config;
  MPEG4ExtensionDescriptorsBox ( ); // optional
}
```

### Semantics

Compressorname in the base class VisualSampleEntry indicates the name of the compressor used with the value “\013HEVC Coding” being recommended (\013 is 11, the length of the string in bytes).

HEVCDecoderConfigurationRecord is defined in ISO/IEC 14496-15.

The storage format of coded video data of layered HEVC (L-HEVC), which includes all the layered HEVC extensions that use the same layered design specified in ISO/IEC 23008-2:2020. These layered HEVC extensions include SHVC, MV-HEVC, and 3D-HEVC.

LHEVCConfigurationBox in a track having a sample entry for single layer HEVC enables the storage of an L-HEVC bitstream in a manner that the HEVC compatible base layer can be used by any plain HEVC file format compliant reader.

The L-HEVC file format allows storage of one or more layers into a track. Storage of multiple layers per track can be used. For example, when a content provider wants to provide a multi-layer bitstream that is not intended for subsetting, or when the bitstream has been created for a few predefined sets of output layers where each layer corresponds to a view (such as 1, 2, 5, or 9 views), tracks can be created accordingly.

A sample in an ‘hvc1’ or ‘hev1’ track with the L-HEVC configuration is an L-HEVC sample, while a sample in an ‘hvc1’ or ‘hev1’ track without the L-HEVC configuration is not an L-HEVC sample.

When the sample entry name is ‘hev2’ or ‘hev3’ and the sample entry includes the HEVC configuration only, the same constraints as specified for the sample entry name ‘hev1’ apply.

An LHEVCConfigurationBox may be present in an ‘hve1’, ‘hev1’, ‘hvc2’, ‘hev2’, ‘hvc3’ or ‘hev3’ sample entry. In this case the HEVCLHVCSampleEntry definition below applies.

Table, below shows for a video track all the possible uses of sample entries, configurations and the L-HEVC tools:

Use of sample entries for HEVC and L-HEVC tracks is illustrated in table 2.

TABLE 2

| sample | with configuration | |
|---|---|---|
| entry name | records | meaning |
| ‘hvc1’ or | HEVC and L-HEVC | An L-HEVC track with both |
| ‘hev1’ | Configurations | NAL units with nuh_layer_id |
| | | equal to 0 and NAL units |
| | | with nuh_layer_id greater |
| | | than 0; Extractors and |
| | | aggregators shall not be present. |
| ‘hvc2’ or | HEVC and L-HEVC | An L-HEVC track with both NAL |
| ‘hev2’ | Configurations | units with nuh_layer_id |
| | | equal to 0 and NAL units with |
| | | nuh_layer_id greater than 0; |
| | | Extractors and aggregators |
| | | may be present; Extractors may |
| | | reference any NAL units; |
| | | constructor_type shall |
| | | be equal to 0 or 2 in extractors; |
| | | Aggregators may both include |
| | | and reference any NAL units. |
| ‘hvc3’ or | HEVC and L-HEVC | An L-HEVC track with both |
| ‘hev3’ | Configurations | NAL units with |
| | | nuh_layer_id equal to 0 and |
| | | NAL units with nuh_layer_id |
| | | greater than 0; Extractors and |
| | | aggregators may be present; |
| | | Extractors may reference |
| | | any NAL units; |
| | | constructor_type shall |
| | | be equal to 0, 2, 3, |
| | | 4, 5 or 6 in extractors; |
| | | Aggregators may both include and |
| | | reference any NAL units. |

```
      class LHEVCConfigurationBox extends Box(‘lhvC’) {
  LHEVCDecoderConfigurationRecord( ) LHEVCConfig;
}
    class HEVCLHVCSampleEntry( ) extends HEVCSampleEntry( ) {
      LHEVCConfigurationBox lhvcconfig;
    }
    // Use this if track is not HEVC compatible
    class LHEVCSampleEntry( ) extends VisualSampleEntry
    (‘lhv1’, or ‘lhe1’) {
      LHEVCConfigurationBox lhvcconfig;
      MPEG4ExtensionDescriptorsBox ( ); // optional
    }
```

### Semantics

When the sample entry is ‘lhv1’ or ‘lhe1’, Compressorname in the base class VisualSampleEntry indicates the name of the compressor used with the value “\014LHEVC Coding” being recommended (\014 is 12, the length of the string “LHEVC Coding” in bytes). When the sample entry is ‘hvc2’, ‘hev2’, ‘hvc3’ or ‘hev3’, Compressorname in the base class VisualSampleEntry indicates the name of the compressor used with the value “\013HEVC Coding” being recommended (\013 is 11, the length of the string “HEVC Coding” in bytes).

### Example Problem

In certain scenarios there is a need to decode a single layer (base layer with nuh_layer_id=0) from the multi-layer bitstream for example, the content provider makes it available only the multi-layer content whereas the player at the client end only supports single layer processing or decoder at the client is a single layer decoder. To enable this scenario, the multilayer bitstream has to be packed in a backward compatible manner so that at least the subset of the content in multilayer bitstream can be consumed with the single layer file readers and single layer decoders.

In such cases there is a need to design the file format carriage to be backward compatible with single layer processing while providing enough information for more sophisticated file parsers to extract and decode multi-layer bitstream

### Another Example Problem

When HEVC compatibility is indicated, it may be necessary to indicate a high enough level for the HEVC base layer to accommodate the bit rate of the entire bitstream, because the bitrate of the base layer includes the NAL units from both the base layer (nuh_layer_id=0) and enhancement layers (nuh_layer_id!=0) are considered as included in the bitrate calculation of HEVC base layer and hence can be fed to the decoder (conformant with only base layer decoding), which is expected to discard those NAL unit it does not recognize. The ISO/IEC 23008-2 or ITU-T H.265 HEVC specification subclause F.7.4.4 on Profiles, Tiers and Levels specifies the following:

The scope to which the profile_tier_level( ) syntax structure applies is specified as follows:
When the profile_tier_level( ) syntax structure is included in an active SPS for the base layer or is the profile_tier_level( ) syntax structure VpsProfileTierLevel[0](the first profile_tier_level( ) struct within the VPS activated for the CVS (coded video sequence)), it applies to the OLS (Output layer set) including all layers in the bitstream but with only the base layer being the output layer.

This case occurs when the ‘hvc1’, ‘hev1’, ‘hvc2’, ‘hev2’, ‘hvc3’ or ‘hev3’ sample entry is used and both HEVC and L-HEVC configurations are present within the said sample entry. However, when an HEVC and L-HEVC configuration is present, on the contrary, the optimal level for the HEVC track is the one that only accommodates the bit rate of the base layer bitstream. In this case, caution should be taken that the profile, tier and level (PTL) in the VPS base (e.g., the first PTL structure in a VPS) might be “greater” than the PTL of the base layer that should be included in the HEVCDecoderConfigurationRecord. Rather, the PTL information in the first PTL structure in the VPS extension is what should be included in HEVCDecoderConfigurationRecord.

The text above is a conformance requirement for the decoder. Either a file writer will have to write a Level requirement in the base bitstream to be high enough to include the non-base layers or the file reader will have to parse the multi-layer bitstream to remove the NAL units which are from non-base layers for the decoder to decode the base layer only.

Typically, in many cases the bitrate of the non-base (enhancement layer, nuh_layer_id!=0) layer is either same as the base layer or significantly higher than the base layer and may not match the Level requirements of the currently deployed decoders (conformant with only base layer decoding). For example, the decoder (conformant with only base layer decoding) is of level 3.1 and the level required by the base layer bitstream is 3.1, however, due to the presence of non-base (enhancement layer, nuh_layer_id!=0) layer NAL units in the bitstream the signaled level of the base layer bitstream is 4.1. For the applications to be backward compatible (decoders conformant with only base layer decoding to be able to decode at least the base layer from a multilayer bitstream) in such cases, they can benefit from the proposed solution.

An example method for a file encapsulator comprises:
receiving a video bitstream represented by two or more layers and comprising parameter sets describing a decoder requirements;
extracting a first layer from the two or more layers from the video bitstream to generate an extracted first layer;
storing the extracted first layer in a first track in a file;
extracting remaining layers of the two or more layers from the video bitstream to generate extracted remaining layers;
storing the extracted remaining layers in the first track along the first layer as an sample auxiliary information associated with the first track;
extracting parameters set from the video bitstream to generate extracted parameters;
re-writing and storing the extracted parameters in the first track;
associating the extracted parameters with the first layer using a first configuration box;
re-writing and storing the extracted parameters in the first track and associate them with the first layer using sample group;
storing the extracted parameters in the first track and associated the extracted parameters with the remaining layers; and
storing parameters in the sample group.

An example method for file parser comprises:
receiving a file;
determining a single layer (e.g., a base layer) and a multi-layer (e.g., a base layer+extra layers) data; and
for a given option extracting data and related parameters sets of the single layer and the multi-layer.
   Track SampleEntry Comprising configurationBox's for all Layers, and Track Comprising Sample Auxiliary Information Boxes

It is assumed herein that there exists a multilayer bitstream with two or more layers. Where the bitstream contains access units for example NAL units with nuh_layer_id=0 and at least one additional layer with NAL units having nuh_layer_id!=0. The multilayer bitstream is encapsulated into track of a file format, for example, ISOBMFF.

The sample entry of a track comprises 4 cc for single layer, however, the sample entry comprises ConfigurationBox's of both the single layer and the ConfigurationBox for the additional layers of a multilayer bitstream.

In an example the HEVCLHVCSampleEntry with the track 4 cc ‘hvc1’ or ‘hev1’ comprises both the HEVCConfigurationBox and the LHEVCConfigurationBox. An example syntax for HEVCLHVCSampleEntry is shown below:

| class HEVCLHVCSampleEntry ( ) extends VisualSampleEntry | |
|---|---|
| (‘hvc1’ or ‘hev1’){ | |
| HEVCConfigurationBox | config0; |
| LHEVCConfigurationBox | config1; |
| MPEG4ExtensionDescriptorsBox ( ); | // optional |

}

In this scenario the file writer can create the file in the following ways:
Case 1: from a HEVC multilayer bitstream with two or more layers for example NAL units with nuh_layer_id=0 and at least one additional layer with NAL units having nuh_layer_id!=0. Include the NAL units of both the HEVC base layer (nuh_layer_id=0) and the NAL units of the additional layers (nuh_layer_id !=0) in the samples of the track; or
Case 2: from a HEVC multilayer bitstream with two or more layers for example NAL units with nuh_layer_id=0 and at least one additional layer with NAL units having nuh_layer_id!=0. Include the NAL units of the HEVC base layer (nuh_layer_id=0) in the samples of the track and include the NAL units of the additional layers (nuh_layer_id !=0) in the sample auxiliary information with aux_info_type (‘saiz’ and ‘saio’ box parameter) equal to the sample entry type (‘lhv1’, or ‘lhe1’)

However, a legacy file reader/client application (which understands HEVCLHVCSampleEntry because of the 4CC code and the presence of both HEVCConfigurationBox and the LHEVCConfigurationBox within the sample entry) cannot distinguish between the two cases described above and would interpret the track to be encapsulated as in example case 1, above, when it encounters a HEVCLHVCSampleEntry.

To avoid the above situation, the various embodiments propose the following example solution(s).

In an embodiment, a restricted scheme is defined with the scheme_type parameter in the SchemeTypeBox set equal to the 4 cc ‘lsai’ (any other suitable 4 cc value may be used).

In an embodiment, when the scheme type is equal to ‘lsai’ it indicates that the track comprises multilayer bitstream (e.g., NAL units with both nuh_layer_id=0 and nuh_layer_id !=0); and the sample entry of the track comprises configuration box mapping to NAL units with nuh_layer_id=0 and configuration box mapping to NAL units with nuh_layer_id!=0. However, the samples of the track carry NAL units with nuh_layer_id=0 and the sample auxiliary information carry the NAL units with nuh_layer_id!=0 with aux_info_type (‘saiz’ and ‘saio’ box parameter) equal to the sample entry type (‘lhv1’, or ‘lhe1’)

In an embodiment, when the scheme type is equal to ‘lsai’ the track may be Restricted track with RestrictedSchemeInfoBox and also encrypted with EncryptedSchmeInfoBox.

In an alternate embodiment, the LHEVCConfigurationBox is moved inside the scheme information box ‘schi’ which resides underthe RestrictedSchemeInfoBox or EncryptedSchemeInfoBox (when the track is encrypted together with the restricted scheme).

In an alternate embodiment, a new SecondaryLayerSAIBox or MultiLayerSAIBox (any other suitable Box name may be used) is defined which is present in the SampleEntry of the track.

In an example embodiment, encapsulate the LHEVCConfigurationBox inside the SecondaryLayerSAIBox or MultiLayerSAIBox present in the SampleEntry of the track.

| class HEVCSampleEntry( ) extends VisualSampleEntry | |
|---|---|
| (‘hvc1’, or ‘hev1’) { | |
| HEVCConfigurationBox | hvcconfig; |
| SecondaryLayerSAIBox | seclsai; |
| MPEG4ExtensionDescriptorsBox ( ); | // optional |

}

In an embodiment, the encapsulation of LHEVCConfigurationBox is allowed inside the SecondaryLayerSAIBox or MultiLayerSAIBox present in the SampleEntry of the track.

In an embodiment, the said SecondaryLayerSAIbox or MultiLayerSAIBox conditionally comprises the aux_info_type and the aux_info_type_parameter parameters.

| class SecondaryLayerSAIBox or MultiLayerSAIBox extends | |
|---|---|
| FullBox(version=0, flags, ‘slsi’){ | |
| if( flags & 1 ){ | |
| unsigned int(32) | aux_info_type; |
| unsigned int(32) | aux_info_type_parameter; |
| } | |
| LHEVCConfigurationBox | lhvcconfig; |

}

In an embodiment, the aux_info_type_parameter may indicate the 4 cc of the multilayer bitstream which is carried in the sample auxiliary information.

In an embodiment, when multiple SAI streams are present in the track the aux_info maps to the specific SAI in the track.

In an alternate embodiment, the sample entry of a track includes the ConfigurationBox of HEVC base layer (nuh_layer_id=0) and the Configuration box's of additional layers (nuh_layer_id!=0) together with a new box called SecondaryLayerSAIBox or MultiLayerSAIBox (any other suitable Box name may be used).

In an example alternate embodiment, the said SecondaryLayerSAIbox or MultiLayerSAIBox includes a mapping from the said ConfigurationBox's in the sampleentry to the SampleAuxiliary information as below.

```
class SecondaryLayerSAIBox or MultiLayerSAIBox extends
FullBox(version=0, flags, ‘slsi’){
  unsigned int(8) number_of_config_records;
  for(i=0; i< number_of_config_records;i++){
    unsigned int(32) config_4cc;
    unsigned int(32) aux_info_type;
    unsigned int(32) aux_info_type_parameter;
  }
}
```

### VPS/SPS of the HEVC Base Layer is Overloaded

When the sample entry of the track is the single layer sample entry (for example, in case of HEVC the sample entry may be ‘hvc1’ or ‘hev1’) and the sample entry comprises both the single layer configuration box and the multilayer configuration box (for example, in case of HEVC, the sample entry contains both the HEVCConfigurationBox and the LHEVCConfigurationBox), the PTL (the Profile, Tier and level structure) values both in the VPS and SPS belonging to the base layer may be oversaturated (for example, in case of HEVC, the PTL values in the SPS of the base layer bitstream is oversaturated as discussed in previous paragraphs).

In an embodiment, a file reader which is compatible with the single layer sample entry (for example, file reader only supports bitstream compatible with HEVCConfigurationBox (NAL Units with nuh_layer_id=0)) may choose to drop the NAL units related to other layers (NAL units with nuh_layer_id !=0) while reconstructing the bitstream from the track parsing.

This would require either a new SPS to be written in the reconstructed bitstream from the file reader/parser which match the PTL value of the base layer (NAL Units with nuh_layer_id=0)) or the SPS of the bitstream to rewritten with new PTL values which match the base layer (NAL Units with nuh_layer_id=0).

Similarly the above bitstream reconstruction operation would require either a new VPS to be written which match the PTL value of the base layer (NAL Units with nuh_layer_id=0)) or the VPS of the bitstream to be rewritten with new PTL values which match the base layer (NAL Units with nuh_layer_id=0).

In an embodiment, a new sample group is defined, for example, the HEVC SPS Parameter set sample group. In an embodiment, the sample group description entry of this sample group contains an HEVC SPS NAL unit with the PTL value matched with only the base layer NAL units.

```
class HEVCSPSParameterSetNALUEntry extends
VisualSampleGroupEntry (‘hsps’) {
  unsigned int(16) hsps_nal_unit_length;
  bit(8*hsps_nal_unit_length) hsps_nal_unit;
}
hsps_nal_unit_length indicates the length in
bytes of the HEVC SPS NAL unit.
```

hsps_nal_unit comprises a HEVC NAL unit as specified in h.265/HEVC/ISO/IEC 23008-2.

In an embodiment, when a sample is mapped to a HEVC SPS parameter set sample group (‘hsps’), it indicates that the HEVC SPS NAL unit contained within the sample group description entry needs to be inserted into the reconstructed AU when the target PTL format corresponds to the PTL format indicated by the grouping_type_parameter field in the SampleToGroupBoxes for the parameter set sample group.

In an embodiment, when a sample group of type ‘hsps’ is present in a HEVC track, a sample shall be marked as belonging to the ‘hsps’ sample group when any of the following is true:
The sample of the HEVC track contains an SPS NAL unit.
The sample references a different sample entry than the previous sample in decoding order and the sample entry contains an SPS NAL unit.

In an embodiment, all instances of the SampleToGroupBox for the HEVC SPS parameter set sample group shall include grouping_type_parameter.

In an embodiment, the grouping_type_parameter field is specified for the HEVC SPS parameter set sample group as follows:
HEVC PTL (Base layer)
PTL (Base layer) specify the PTL format of the target reconstructed bitstream for which a HEVC SPS NAL unit is to be inserted.

In an embodiment, a new sample group is defined called the HEVC VPS Parameter set sample group. In an embodiment, the sample group description entry of this sample group comprises an HEVC VPS NAL unit with the PTL value matched with only the base layer NAL units.

```
class HEVCVPSParameterSetNALUEntry extends
VisualSampleGroupEntry (‘hvps’) {
  unsigned int(16) hvps_nal_unit_length;
  bit(8*hvps_nal_unit_length) hvps_nal_unit;
}
```

hvps_nal_unit_length indicates the length in bytes of the HEVC VPS NAL unit.

hvps_nal_unit comprises a HEVC NAL unit as specified in h.265/HEVC/ISO/IEC 23008-2.

In an embodiment, when a sample is mapped to a HEVC VPS parameter set sample group (‘hvps’), it indicates that the HEVC VPS NAL unit contained within the sample group description entry needs to be inserted into the reconstructed AU when the target PTL format corresponds to the PTL format indicated by the grouping_type_parameter field in the SampleToGroupBoxes for the parameter set sample group.

In an embodiment, when a sample group of type ‘hvps’ is present in a HEVC track, a sample shall be marked as belonging to the ‘hvps’ sample group when any of the following is true:
The sample of the HEVC track contains an VPS NAL unit.
The sample references a different sample entry than the previous sample in decoding order and the sample entry contains an VPS NAL unit.

In an embodiment, all instances of the SampleToGroupBox for the HEVC VPS parameter set sample group shall include grouping_type_parameter.

In an embodiment, the grouping_type_parameter field is specified for the HEVC VPS parameter set sample group as follows:
HEVC PTL (Base layer)
PTL (Base layer) specify the PTL format of the target reconstructed bitstream for which a HEVC VPS NAL unit is to be inserted.

In an alternate embodiment, a new sample group is defined called the HEVC VPSSPS Parameter set sample group. In an embodiment, the sample group description entry of this sample group contains both the HEVC VPS NAL unit and the HEVC SPS NAL unit with the PTL value matched with only the base layer NAL units.

In an embodiment, when a sample is mapped to a HEVC VPSSPS parameter set sample group, it indicates that the HEVC VPS NAL unit and the HEVC SPS NAL contained within the sample group description entry needs to be inserted into the reconstructed AU when the target PTL format corresponds to the PTL format indicated by the grouping_type_parameter field in the SampleToGroupBoxes for the parameter set sample group.

In an embodiment, when HEVC VPSSPS Parameter set sample group is present in a HEVC track, a sample shall be marked as belonging to the HEVC VPSSPS Parameter set sample group sample group when any of the following is true:
The sample of the HEVC track contains an VPS NAL unit and/or the SPS NAL unit.
The sample references a different sample entry than the previous sample in decoding order and the sample entry contains an VPS NAL unit and/or SPS NAL unit.

In an embodiment, all instances of the SampleToGroupBox for the HEVC VPSSPS Parameter set sample group shall include grouping_type_parameter.

In an embodiment, the grouping_type_parameter field is specified for the HEVC VPSSPS Parameter set sample group as follows:
HEVC PTL (Base layer)

PTL (Base layer) specify the PTL format of the target reconstructed bitstream for which a HEVC VPS NAL unit and/or the HEVC SPS NAL unit is to be inserted.

In an alternate embodiment, a new sample group is defined called the HEVC PTL sample group.

In an embodiment, this sample group is used in HEVC track with HEVCLHVCSampleEntry.

In an embodiment, each sample group description entry indicates the SPS in which the PTL information is to be rewritten when the file reader drops the NAL units for the non-base layers (nuh_layer_id !=0).

In an embodiment, to ease SPS rewriting in response to base layer selection, each sample group description entry may comprise a HEVCPTLRewritingInfomationStruct structure that comprises following:
the length (in bits) of PTL syntax elements.
the bit position of PTL syntax elements in the containing RBSP;
a flag indicating whether start code emulation prevention bytes are present before or within PTL
the SPS parameter set ID of the parameter set containing the PTL to be rewritten.

### Syntax of HEVCPTLRewritingInfomationStruct

```
aligned(8) class HEVCPTLRewritingInfomationStruct( )
{
  unsigned int(12) ptl_bit_pos;
  unsigned int(1) start_code_emul_flag;
  unsigned int(4) sps_id;
  bit(3) reserved = 0;
}
```

### Semantics of HEVCPTLRewritingInfomationStruct

ptl_bit_pos specifies the bit position starting from 0 of the first bit of the PTL syntax element in the referenced SPS RBSP.

start_code_emul_flag equal to 0 specifies that start code emulation prevention bytes are not present before or within PTL in the referenced SPS NAL unit. start_code_emul_flag equal to 1 specifies that start code emulation prevention bytes may be present before or within PTL in the referenced SPS NAL unit.

sps_id, when present, specifies the SPS ID of the SPS applying to the samples mapped to this sample group description entry.

### Syntax of HevcSpsPtlEntry

aligned(8) class HevcSpsPtlEntry( ) extends
VisualSampleGroupEntry(‘hptl’)
{
HEVCPTLRewritingInfomationStruct ( ) ptl_rewriting_info;
}

In an alternate embodiment, each sample group description entry of the HEVC PTL sample group indicates the VPS in which the PTL information is to be rewritten when the file reader drops the NAL units for the non-base layers (nuh_layer_id !=0).

In an embodiment, to ease VPS rewriting in response to base layer selection, each sample group description entry may contain a HEVCPTLRewritingInfomationStruct structure that comprises:
the length (in bits) of PTL syntax elements;
the bit position of PTL syntax elements in the containing RBSP;
a flag indicating whether start code emulation prevention bytes are present before or within PTL; or
the VPS parameter set ID of the parameter set containing the PTL to be rewritten.

### Syntax of HEVCPTLRewritingInfomationStruct

```
aligned(8) class HEVCPTLRewritingInfomationStruct( )
{
  unsigned int(12) ptl_bit_pos;
  unsigned int(1) start_code_emul_flag;
  unsigned int(4) vps_id;
  bit(3) reserved = 0;
}
```

### Semantics of HEVCPTLRewritingInfomationStruct

ptl_bit_pos specifies the bit position starting from 0 of the first bit of the PTL syntax element in the referenced SPS RBSP.

start_code_emul_flag equal to 0 specifies that start code emulation prevention bytes are not present before or within PTL in the referenced VPS NAL unit. start_code_emul_flag equal to 1 specifies that start code emulation prevention bytes may be present before or within PTL in the referenced VPS NAL unit.

vps_id, when present, specifies the VPS ID of the VPS applying to the samples mapped to this sample group description entry.

In an alternate embodiment, each sample group description entry of the HEVC PTL sample group indicates the VPS and/or SPS in which the PTL information is to be rewritten when the file reader drops the NAL units for the non-base layers (nuh_layer_id !=0).

In an embodiment, to ease VPS and/or SPS rewriting in response to base layer selection, each sample group description entry may contain a HEVCPTLRewritingInfomationStruct structure that contains:
the length (in bits) of PTL syntax elements;
the bit position of PTL syntax elements in the containing RBSP;
a flag indicating whether start code emulation prevention bytes are present before or within PTL
the VPS parameter set ID of the parameter set containing the PTL to be rewritten.
the SPS parameter set ID of the parameter set containing the PTL to be rewritten.

### Syntax of HEVCPTLRewritingInfomationStruct

```
aligned(8) class HEVCPTLRewritingInfomationStruct( )
{
  unsigned int(2) vps_sps_present;
  if (vps_sps_present == 0){
unsigned int(4) vps_id;
  unsigned int(12) ptl_bit_pos;
  unsigned int(1) start_code_emul_flag;
  bit(3) reserved = 0;
}
if (vps_sps_present == 1){
unsigned int(4) sps_id;
  unsigned int(12) ptl_bit_pos;
  unsigned int(1) start_code_emul_flag;
  bit(3) reserved = 0;
}
if (vps_sps_present == 2){
unsigned int(4) sps_id;
  unsigned int(12) ptl_bit_pos_sps;
  unsigned int(1) start_code_emul_flag_sps;
unsigned int(4) vps_id;
  unsigned int(12) ptl_bit_pos_vps;
  unsigned int(1) start_code_emul_flag_vps;
  bit(6) reserved = 0;
}
}
```

### Semantics of HEVCPTLRewritingInfomationStruct

ptl_bit_pos specifies the bit position starting from 0 of the first bit of the PTL syntax element in the referenced SPS RBSP.

start_code_emul_flag equal to 0 specifies that start code emulation prevention bytes are not present before or within PTL in the referenced VPS NAL unit. start_code_emul_flag equal to 1 specifies that start code emulation prevention bytes may be present before or within PTL in the referenced VPS NAL unit.

vps_id, when present, specifies the VPS ID of the VPS applying to the samples mapped to this sample group description entry.

In an embodiment, SAI that corresponds to a layer could be stored in mdat consecutively with other SAIs of the same layer and as consecutive chunks which come after the base layer chunks. This enables efficient skipping of additional layer data when such data is not needed. Where samples within the media data are grouped into chunks. Chunks can be of different sizes, and the samples within a chunk can have different sizes.

In another embodiment, chunks that related to different layers may be grouped together and stored in segments or track fragments. Storing such layers in SAIs in their own fragments enable fast switching between base layer and other layers in a segment, hence increases efficiency in random access, layer skipping or individual layer related SAI data downloading in progressive downloading and MPEG DASH streaming use cases.

To enable this, ‘saiz’ and ‘saio’ boxes are efficiently used to byte storage-wise separate data that relate to base layer and other layers, isolating access and download of each layer's data independently.

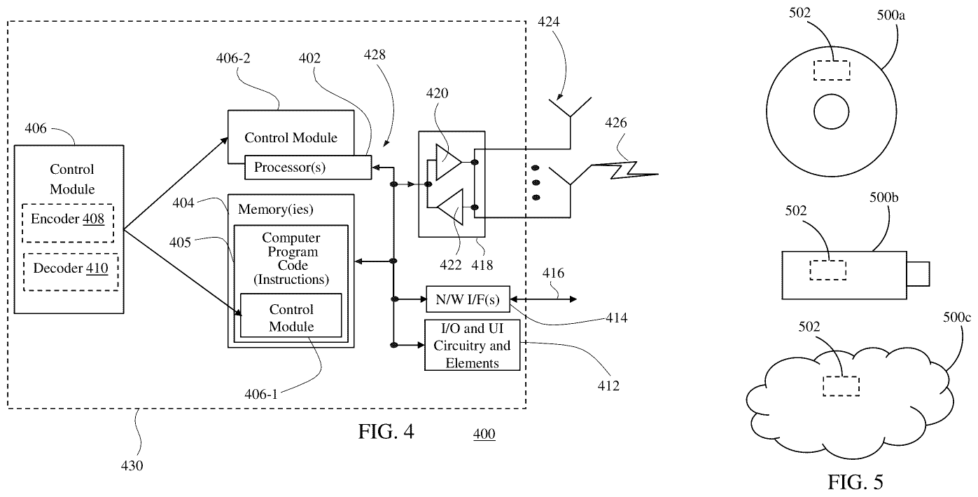

FIG. 4 is an example apparatus 400, which may be implemented in hardware, configured to implement the examples described herein. The apparatus 400 comprises at least one processor 402 (e.g., an FPGA and/or CPU), at least one memory 404 including computer program code 405, the computer program code 405 having instructions to carry out the methods described herein, wherein the at least one memory 404 and the computer program code 405 are configured to, with the at least one processor 402, cause the apparatus 400 to implement circuitry, a process, component, module, or function (implemented with control module 406) to implement the examples described herein, including enabling backward compatible multilayer bitstream in single layer tracks. Optionally included encoder 408 of the control module 406 implements encoding based on the examples described herein, and optionally included decoder 410 implements decoding based on the examples described herein. The at least one memory 404 may be a non-transitory memory, a transitory memory, a volatile memory (e.g. RAM), or a non-volatile memory (e.g., ROM).

The apparatus 400 includes a display and/or I/O interface 412, which includes user interface (UI) circuitry and elements, that may be used to display features or a status of the methods described herein (e.g., as one of the methods is being performed or at a subsequent time), or to receive input from a user such as with using a keypad, camera, touchscreen, touch area, microphone, biometric recognition, one or more sensors, etc. The apparatus 400 includes one or more communication e.g. network (N/W) interfaces (I/F(s)) 414. The communication I/F(s) 414 may be wired and/or wireless and communicate over the Internet/other network(s) via any communication technique including via one or more links 416. The communication I/F(s) 414 may comprise one or more transmitters or one or more receivers.

The transceiver 418 comprises one or more transmitters 420 and one or more receivers 422. The transceiver 418 and/or communication I/F(s) 414 may comprise standard well-known components such as an amplifier, filter, frequency-converter, (de)modulator, and encoder/decoder circuitries and one or more antennas, such as antennas 424 used for communication over wireless link 426.

The control module 406 of the apparatus 400 comprises one of or both parts 406-1 and/or 406-2, which may be implemented in a number of ways. The control module 406 may be implemented in hardware as control module 406-1, such as being implemented as part of the at least one processor 402. The control module 406-1 may be implemented also as an integrated circuit or through other hardware such as a programmable gate array. In another example, the control module 406 may be implemented as control module 406-2, which is implemented as computer program code (having corresponding instructions) 405 and is executed by the at least one processor 402. For instance, the at least one memory 404 store instructions that, when executed by the at least one processor 402, cause the apparatus 400 to perform one or more of the operations as described herein. Furthermore, the at least one processor 402, the at least one memory 404, and example algorithms (e.g., as flowcharts and/or signaling diagrams), encoded as instructions, programs, or code, are means for causing performance of the operations described herein.

The apparatus 400 to implement the functionality of control module 406 may correspond to any of the apparatuses depicted herein. Alternatively, apparatus 400 and its elements may not correspond to any of the other apparatuses depicted herein, as apparatus 400 may be part of a self-organizing/optimizing network (SON) node or other node, such as a node in a cloud.

The apparatus 400 may also be distributed throughout the network including within and between apparatus 400 and any network element (such as a base station and/or terminal device and/or user equipment).

Interface 428 enables data communication and signaling between the various items of apparatus 400, as shown in FIG. 4. For example, the interface 428 may be one or more buses such as address, data, or control buses, and may include any interconnection mechanism, such as a series of lines on a motherboard or integrated circuit, fiber optics or other optical communication equipment, and the like. Computer program code (e.g. instructions) 405, including control module 406 may comprise object-oriented software configured to pass data or messages between objects within computer program code 405. The apparatus 400 need not comprise each of the features mentioned, or may comprise other features as well. The various components of apparatus 400 may at least partially reside in a housing 430, or a subset of the various components of apparatus 400 may at least partially be located in different housings, which different housings may include housing 430.

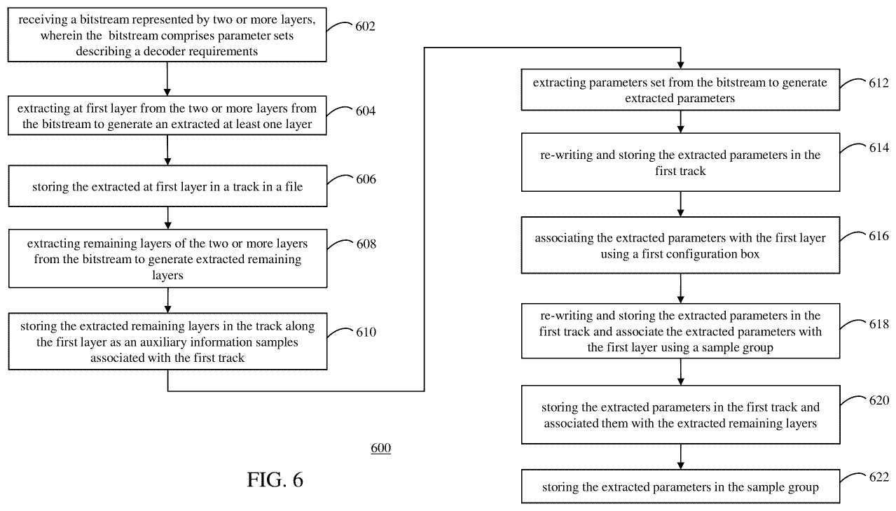

FIG. 5 shows a schematic representation of non-volatile memory media 500a (e.g. computer/compact disc (CD) or digital versatile disc (DVD)) and 500b (e.g. universal serial bus (USB) memory stick) and 500c (e.g. cloud storage for downloading instructions and/or parameters 502 or receiving emailed instructions and/or parameters 502) storing instructions and/or parameters 502 which when executed by a processor allows the processor to perform one or more of the operations of the methods described herein. Instructions and/or parameters 502 may represent or correspond to a non-transitory computer readable medium.

FIG. 6 is an example method 600 to implement the embodiments described herein, in accordance with an embodiment. At 602, the method 600 includes receiving a bitstream represented by two or more layers, wherein the bitstream comprises parameter sets describing a decoder requirements. At 604, the method 600 includes extracting at first layer from the two or more layers from the bitstream to generate an extracted at least one layer. At 606, the method 600 includes storing the extracted at first layer in a track in a file. At 608, the method 600 includes extracting remaining layers of the two or more layers from the bitstream to generate extracted remaining layers. At 610, the method 600 includes storing the extracted remaining layers in the track along the first layer as an auxiliary information samples associated with the first track. At 612, the method 600 includes extracting parameters set from the bitstream to generate extracted parameters. At 614, the method 600 includes re-writing and storing the extracted parameters in the first track. At 616, the method 600 includes associating the extracted parameters with the first layer using a first configuration box. At 618, the method 600 includes re-writing and storing the extracted parameters in the first track and associate the extracted parameters with the first layer using a sample group. At 620, the method 600 includes storing the extracted parameters in the first track and associated them with the extracted remaining layers. At 622, the method 600 includes storing the extracted parameters in the sample group.

The method 600 may be performed with an apparatus described herein, for example, any apparatus of FIG. 1 to FIG. 4, or any other apparatus described herein.

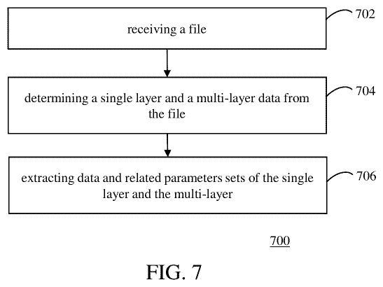

FIG. 7 is an example method 700 to implement the embodiments described herein, in accordance with an embodiment. At 702, the method 700 includes receiving a file. At 704, the method 700 includes determining a single layer and a multi-layer data from the file. At 706, the method 700 includes extracting data and related parameters sets of the single layer and the multi-layer.

In an embodiment, the method 700 may further include, wherein, when a file reader is compatible with the single layer, the method further comprises: dropping network abstraction layer (NAL) units related to layers other than the single layer while reconstructing a bitstream.

The method 700 may be performed with an apparatus described herein, for example, any apparatus of FIG. 1 to FIG. 4, or any other apparatus described herein.

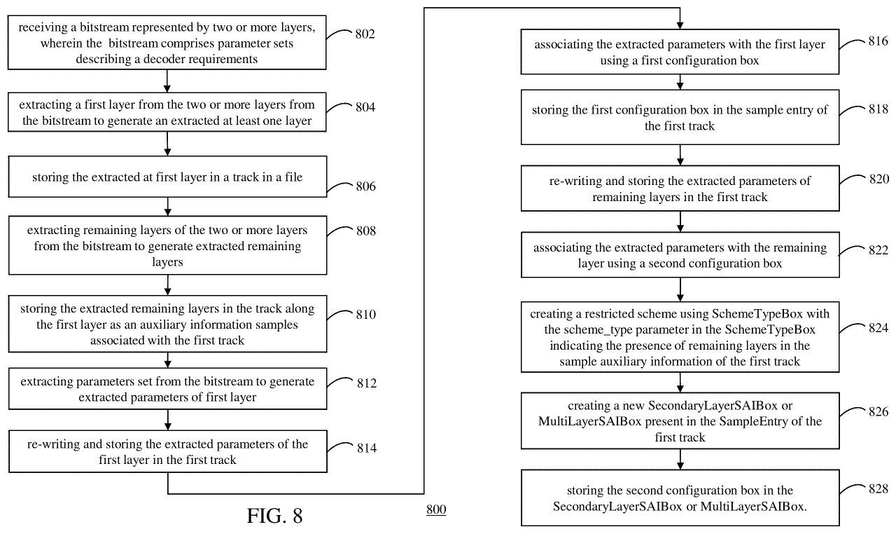

FIG. 8 is an example method 800 to implement the embodiments described herein, in accordance with an embodiment. At 802, the method 800 includes receiving a video bitstream represented by two or more layers and comprising parameter sets describing a decoder requirements. At 804, the method 800 includes extracting a first layer from the two or more layers from the video bitstream to generate an extracted first layer. At 806, the method 800 includes storing the extracted first layer in a first track in a file. At 808, the method 800 includes extracting remaining layers of the two or more layers from the video bitstream to generate extracted remaining layers. At 810, the method 800 includes storing the extracted remaining layers in the first track along the first layer as an sample auxiliary information associated with the first track. At 812, the method 800 includes extracting parameters set from the video bitstream to generate extracted parameters of first layer. At 814, the method 800 includes re-writing and storing the extracted parameters of first layer in the first track. At 816, the method 800 includes associating the extracted parameters with the first layer using a first configuration box. At 818, the method 800 includes storing the first configuration box in the sample entry of the first track. At 820, the method 800 includes re-writing and storing the extracted parameters of remaining layers in the first track. At 822, the method 800 includes associating the extracted parameters with the remaining layer using a second configuration box. At 824, the method 800 includes creating a restricted scheme using SchemeTypeBox with the scheme_type parameter in the SchemeTypeBox indicating the presence of remaining layers in the sample auxiliary information of the first track. At 826, the method 800 includes creating a new SecondaryLayerSAIBox or MultiLayerSAIBox present in the SampleEntry of the first track. At 828, the method 800 includes storing the second configuration box in the SecondaryLayerSAIBox or MultiLayerSAIBox.

The method 800 may be performed with an apparatus described herein, for example, any apparatus of FIG. 1 to FIG. 4, or any other apparatus described herein.

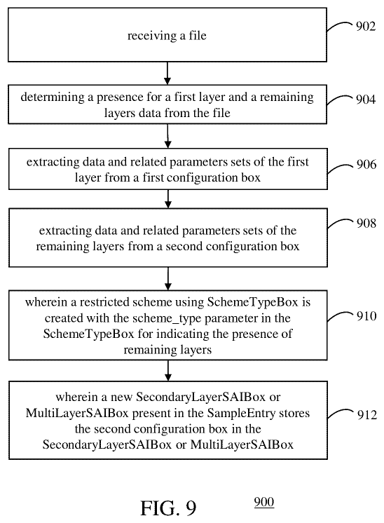

FIG. 9 is an example method 900 to implement the embodiments described herein, in accordance with an embodiment. At 902, the method 900 includes receiving a file. At 904, the method 900 determining a presence for a first layer and a remaining layers data from the file. At 906, the method 900 includes extracting data and related parameters sets of the first layer from a first configuration box. At 908, the method 900 includes extracting data and related parameters sets of the remaining layers from a second configuration box. At 910, the method 900 includes wherein a restricted scheme using SchemeTypeBox is created with the scheme_type parameter in the SchemeTypeBox for indicating the presence of remaining layers. At 912, the method 900 includes wherein a new SecondaryLayerSAIBox or MultiLayerSAIBox present in the SampleEntry stores the second configuration box in the SecondaryLayerSAIBox or MultiLayerSAIBox.

The method 900 may be performed with an apparatus described herein, for example, any apparatus of FIG. 1 to FIG. 4, or any other apparatus described herein.

As described above, FIGS. 6 to 9 include flowcharts of an apparatus (e.g. 100, 400, or any other apparatuses described herein), method, and computer program product according to certain example embodiments. It will be understood that each block of the flowcharts, and combinations of blocks in the flowcharts, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory (e.g. 58, 125, or 404) of an apparatus employing an embodiment of the present invention and executed by processing circuitry (e.g., 56, 120, or 402) of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture, the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

A computer program product is therefore defined in those instances in which the computer program instructions, such as computer-readable program code portions, are stored by at least one non-transitory computer-readable storage medium with the computer program instructions, such as the computer-readable program code portions, being configured, upon execution, to perform the functions described above, such as in conjunction with the flowchart(s) of FIGS. 6 to 9. In other embodiments, the computer program instructions, such as the computer-readable program code portions, need not be stored or otherwise embodied by a non-transitory computer-readable storage medium, but may, instead, be embodied by a transitory medium with the computer program instructions, such as the computer-readable program code portions, still being configured, upon execution, to perform the functions described above.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, may be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Some embodiments have been described in relation to one or more neural networks performing visual temporal extrapolation. It is to be understood that embodiments can be realized with any generative modelling neural networks.

In the above, some example embodiments have been described with the help of syntax of the bitstream. It needs to be understood, however, that the corresponding structure and/or computer program may reside at the encoder for generating the bitstream and/or at the decoder for decoding the bitstream.

In the above, where example embodiments have been described with reference to an encoder, it needs to be understood that the resulting bitstream and the decoder have corresponding elements in them. Likewise, where example embodiments have been described with reference to a decoder, it needs to be understood that the encoder has structure and/or computer program for generating the bitstream to be decoded by the decoder.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Accordingly, the description is intended to embrace all such alternatives, modifications and variances which fall within the scope of the appended claims. Although specific terms are employed herein, they are used in a generic and descriptive sense only and not for purposes of limitation.

It should be understood that the foregoing description is only illustrative. Various alternatives and modifications may be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

References to a ‘computer’, ‘processor’, etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device such as instructions for a processor, or configuration settings for a fixed-function device, gate array or programmable logic device, and the like.

As used herein, the term ‘circuitry’ may refer to any of the following: (a) hardware circuit implementations, such as implementations in analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even when the software or firmware is not physically present. This description of ‘circuitry’ applies to uses of this term in this application. As a further example, as used herein, the term ‘circuitry’ would also cover an implementation of merely a processor (or multiple processors) or a portion of a processor and its (or their) accompanying software and/or firmware. The term ‘circuitry’ would also cover, for example and when applicable to the particular element, a baseband integrated circuit or applications processor integrated circuit for a mobile phone or a similar integrated circuit in a server, a cellular network device, or another network device.

Circuitry or Circuit: As used in this application, the term ‘circuitry’ or ‘circuit’ may refer to one or more or all of the following:
(a) hardware-only circuit implementations (such as implementations in only analog and/or digital circuitry); and
(b) combinations of hardware circuits and software, such as (as applicable):
   (i) a combination of analog and/or digital hardware circuit(s) with software/firmware; and
   (ii) any portions of hardware processor(s) with software (including digital signal processor(s)), software, and memory(ies) that work together to cause an apparatus, such as a mobile phone or server, to perform various functions); and
(c) hardware circuit(s) and/or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example, and when applicable to the particular claim element, a baseband integrated circuit or processor integrated circuit for a mobile device or a similar integrated circuit in server, a cellular network device, or other computing or network device.

What is claimed is:

1. An apparatus comprising:
at least one processor; and
at least one memory storing instructions that, when executed by the at least one processor, cause the apparatus at least to perform:
receiving a bitstream represented by two or more layers, wherein the bitstream comprises parameter sets describing a decoder requirements;
extracting a first layer from the two or more layers from the bitstream to generate an extracted at least one layer;
storing the extracted first layer in a track in a file;
extracting remaining layers of the two or more layers from the bitstream to generate extracted remaining layers;
storing the extracted remaining layers in the track along the first layer as an auxiliary information samples associated with the first track;
extracting parameters set from the bitstream to generate extracted parameters;
re-writing and storing the extracted parameters in the first track;
associating the extracted parameters with the first layer using a first configuration box;
re-writing and storing the extracted parameters in the first track and associate the extracted parameters with the first layer using a sample group;
storing the extracted parameters in the first track and associated them with the extracted remaining layers; and
storing the extracted parameters in the sample group.

2. The apparatus of claim 1, wherein a sample entry comprises the first configuration box and a second configuration box comprises the remaining layers.

3. The apparatus of claim 2, wherein the apparatus is caused to perform: creating the file comprising:
network abstraction layer units of a base layer with layer identity equal to 0 and NAL units of the additional layers with layer identity not equal to 0 in samples of the track; or
sample auxiliary information with auxiliary information type comprising a sample entry type.

4. The apparatus of claim 3, wherein the apparatus is further caused to perform: defining a restricted scheme comprising a scheme type parameter in a scheme type box set equal to a 4 character code lsai.

5. The apparatus of claim 4, wherein when the scheme type is equal to lsai it indicates that a track comprises a multilayer bitstream and the sample entry of the track comprises the configuration box mapping to a network abstraction layer (NAL) units with a layer identity equal to 0 and a configuration box mapping to NAL units with layer identity not equal to 0.

6. The apparatus of claim 4, when the scheme type is equal to lsai, the track is restricted track with restricted scheme information box and encrypted with encrypted scheme information box.

7. The apparatus of claim 6, wherein the when the track is encrypted together with the restricted scheme, the second configuration box is moved inside the scheme information box, wherein the scheme information box resides under the restricted scheme information box or encrypted scheme information box.

8. The apparatus of claim 7, wherein the apparatus is further caused to perform: defining a secondary layer box or a multilayer box comprised in a sample entry of the track, wherein the secondary layer box or multilayer box indicates that the track comprises the multilayer bitstream.

9. The apparatus of claim 8, wherein the apparatus is further caused to perform: encapsulating the second configuration box inside the secondary layer box or the multilayer box comprised in the sample entry of the track.

10. The apparatus of any of the claim 8 or 9, wherein the secondary layer box or the multilayer box comprise following parameters: auxiliary information type and auxiliary information type parameter.

11. The apparatus of claim 10, wherein when multiple streams are present in the track the auxiliary information type and auxiliary information type parameter map to a specific track.

12. The apparatus of claim 2, wherein when the sample entry of the track is a single layer sample entry and the sample entry comprises the first configuration box and the second configuration box, a profile, tier and level (PTL) structure values in a video parameter set (VPS) and a sequence parameter set (SPS) belonging to a base layer is oversaturated.

13. The apparatus of claim 1, wherein NAL units related to the remaining layers are dropped by a file reader compatible with the single layer sample entry, during reconstruction of the bitstream from the track.

14. The apparatus of claim 1, wherein apparatus is further caused to perform: defining a high efficiency video codec sequence parameter set (HEVCSPS) sample group, wherein a sample group description entry of HVECSPS sample group comprises an HEVCSPS NAL unit with a profile, tier and level (PTL) value matched with base layer NAL units.

15. The apparatus of claim 14, wherein when a sample is mapped to the HEVCSPS sample group it indicates that the HEVCSPS NAL unit comprised within the sample group description entry needs to be inserted into a reconstructed AU, when a target PTL format corresponds to a PTL format indicated by the grouping type parameter field in sample to group boxes for the parameter set sample group.

16. The apparatus of claim 14, wherein when HSPS is comprised in a high efficiency video codec track, a sample is marked as belonging to the HSPS sample group when any of the following is true:
the sample of a high efficiency video codec (HEVC) track comprises a sequence parameter set (SPS) NAL unit; or
the sample references a different sample entry than a previous sample in decoding order, and the sample entry comprises the SPS NAL unit.

17. The apparatus of any of the claims 14 to 16, wherein instances of the sample to a group box for the HEVCSPS sample group comprises a grouping type parameter.

18. The apparatus of claim 17, wherein the grouping type parameter field for the HEVC SPS parameter set sample group comprises:
a HEVC PTL for a base layer; and
a PTL that specifies a PTL format of a target reconstructed bitstream for which a HEVCSPS NAL unit is to be inserted.

19. The apparatus of claim 1, wherein the apparatus is caused to perform: defining the high efficiency video codec video parameter set (HEVCVPS) sample group, wherein, the sample group description entry of the HEVCVPS sample group comprises an HEVCVPS NAL unit with a profile, tier and level (PTL) value matched with base layer NAL units.

20. The apparatus of claim 19, wherein when a sample mapped to a HEVCVPS sample group it indicates that the HEVCVPS NAL unit comprised within the sample group description entry needs to be inserted into the reconstructed AU when a target PTL format corresponds to the PTL format indicated by the grouping type parameter field in the sample to group box for the HEVCVPS sample group.

21. The apparatus of claim 20, wherein when a sample group of type HEVCVPS sample group is comprised in a high efficiency video codec (HEVC) track, a sample is marked as belonging to the HEVCVPS sample group when any of following is true:
sample of a HEVC track comprises an video parameter sequence NAL unit; or
sample references a different sample entry than a previous sample in decoding order and the sample entry comprise the VPS NAL unit.

22. The apparatus of any of claim 18 or 19, wherein instances of a sample to group box for the HEVCVPS sample group includes grouping type parameter.

23. The apparatus of claim 22, wherein the grouping type parameter field specified for the HEVCVPS sample group comprises:
a HEVC PTL; and
a PTL for base layer that specifies a PTL format of a target reconstructed bitstream
for which a HEVCVPS NAL unit is to be inserted.

24. The apparatus of claim 1, wherein the apparatus is further caused to perform: defining a high efficiency video codec video parameter set and sequence parameter set HEVCVPSSPS sample group, wherein a sample group description entry of HEVCVPSSPS parameter set sample group comprises a high efficiency video (HEVC) video parameter set (VPS) network abstract layer (NAL) unit and the HEVC sequence parameter set (SPS) NAL unit with a profile, tier and level (PTL) value matched with base layer NAL units.

25. The apparatus of claim 24, wherein when a sample mapped to a HEVCVPSSPS parameter set sample group it indicates that the HEVC VPS NAL unit and the HEVC SPS NAL unit comprised within a sample group description entry needs to be inserted into a reconstructed AU when a target PTL format corresponds to a PTL format indicated by the grouping type parameter field in the sample to group boxes for the parameter set sample group.

26. The apparatus of any of the claim 24 or 25, wherein when the HEVCVPSSPS sample group is present in a HEVC track, a sample is marked as belonging to the HEVCVPSSPS parameter set sample group when any of the following is true:
a sample of a HEVC track comprises an VPS NAL unit and/or the SPS NAL unit; or
sample references a different sample entry than a previous sample in decoding order and the sample entry comprises an VPS NAL unit and/or SPS NAL unit.

27. The apparatus of any of the claims 24 to 26, wherein instances a sample to group box for the HEVCVPSSPS parameter set sample group comprises grouping type parameter.

28. The apparatus of claim 27, wherein the grouping type parameter field specified for the HEVCVPSSPS parameter set sample group comprises:
an HEVC PTL; or
a PTL for based that species the PTL format of a target reconstructed bitstream for which a HEVC VPS NAL unit and/or the HEVC SPS NAL unit is to be inserted.

29. The apparatus of any of claims 24 to 26, wherein the apparatus is further caused to perform defining a HEVC PTL sample group, and wherein, a HEVC PTL sample group is used in the HEVC track with HEVC LHVC sample entry.

30. The apparatus of claim 29, wherein each sample group description entry indicates the SPS in which the PTL information is to be rewritten when the file reader drops the NAL units for the non-base layers.

31. The apparatus of the claim 30, wherein each sample group description entry comprises a rewriting information structure comprising:
a length of profile, tier and level (PTL) syntax elements;
a bit position of PTL syntax elements in a raw byte sequence payload (RBSP);
a flag indicating whether to start code emulation prevention bytes are present before or within PTL; and
an SPS parameter set identifier of a parameter set comprising the PTL to be rewritten.

32. The apparatus of claim 29, wherein each sample group description entry of the HEVC PTL sample group indicates a VPS in which the PTL information is to be rewritten when the file reader drops the NAL units for the non-base layers.

33. The apparatus of the claim 32, wherein each sample group description entry comprises a HEVC PTL rewriting information structure comprising:
the length of PTL syntax elements;
the bit position of PTL syntax elements in the containing RBSP;
a flag indicating whether start code emulation prevention bytes are present before or within PTL; and/or
the VPS parameter set identifier of the parameter set containing the PTL to be rewritten.

34. The apparatus of claim 29, wherein each sample group description entry of the HEVC PTL sample group indicates the VPS and/or SPS in which the PTL information is to be rewritten when the file reader drops the NAL units for the non-base layers.

35. The apparatus of claim 34, wherein, in response to base layer selection, each sample group description entry comprises a HEVC PTL rewriting information structure comprising one or more of the following:
a length of PTL syntax elements;
the bit position of PTL syntax elements in the containing RBSP;
a flag indicating whether start code emulation prevention bytes are present before or within PTL;
the VPS parameter set identifier of the parameter set containing the PTL to be rewritten; and/or
the SPS parameter set identifier of the parameter set containing the PTL to be rewritten.

36. The apparatus of claim 9, wherein a SAI corresponding a layer is stored in mdat consecutively with other SAIs of same layer and as consecutive chunks which come after the base layer chunks.

37. The apparatus of claim 9, wherein chunks relating to different layers are grouped together and stored in segments or track fragments.

38. An apparatus comprising:
at least one processor; and
at least one memory storing instructions that, when executed by the at least one processor, cause the apparatus at least to perform:
receiving a file;
determining a single layer and a multi-layer data from the file; and
extracting data and related parameters sets of the single layer and the multi-layer.

39. The apparatus of claim 38, wherein, when the apparatus is compatible with the single layer, the apparatus is further caused to perform: dropping network abstraction layer (NAL) units related to layers other than the single layer while reconstructing a bitstream.

40. An apparatus comprising:
at least one processor; and
at least one memory storing instructions that, when executed by the at least one processor, cause the apparatus at least to perform:
receiving a video bitstream represented by two or more layers and comprising parameter sets describing a decoder requirements;
extracting a first layer from the two or more layers from the video bitstream to generate an extracted first layer;
storing the extracted first layer in a first track in a file;
extracting remaining layers of the two or more layers from the video bitstream to generate extracted remaining layers;
storing the extracted remaining layers in the first track along the first layer as an sample auxiliary information associated with the first track;
extracting parameters set from the video bitstream to generate extracted parameters of first layer;
re-writing and storing the extracted parameters of first layer in the first track;
associating the extracted parameters with the first layer using a first configuration box;
storing the first configuration box in the sample entry of the first track;
re-writing and storing the extracted parameters of remaining layers in the first track associating the extracted parameters with the remaining layer using a second configuration box;
creating a restricted scheme using SchemeTypeBox with the scheme_type parameter in the SchemeTypeBox indicating the presence of remaining layers in the sample auxiliary information of the first track;
creating a new SecondaryLayerSAIBox or MultiLayerSAIBox present in the SampleEntry of the first track; and
storing the second configuration box in the SecondaryLayerSAIBox or MultiLayerSAIBox.

41. An apparatus comprising:
at least one processor; and
at least one memory storing instructions that, when executed by the at least one processor, cause the apparatus at least to perform:
receiving a file;
determining a presence for a first layer and a remaining layers data from the file;
extracting data and related parameters sets of the first layer from a first configuration box;
extracting data and related parameters sets of the remaining layers from a second configuration box;
wherein a restricted scheme using SchemeTypeBox is created with the scheme_type parameter in the SchemeTypeBox for indicating the presence of remaining layers; and
wherein a new SecondaryLayerSAIBox or MultiLayerSAIBox present in the SampleEntry stores the second configuration box in the SecondaryLayerSAIBox or MultiLayerSAIBox.

42. A method comprising:
receiving a bitstream represented by two or more layers, wherein the bitstream comprises parameter sets describing a decoder requirements;
extracting a first layer from the two or more layers from the bitstream to generate an extracted at least one layer;
storing the extracted first layer in a track in a file;
extracting remaining layers of the two or more layers from the bitstream to generate extracted remaining layers;
storing the extracted remaining layers in the track along the first layer as an auxiliary information samples associated with the first track;
extracting parameters set from the bitstream to generate extracted parameters;
re-writing and storing the extracted parameters in the first track;
associating the extracted parameters with the first layer using a first configuration box;
re-writing and storing the extracted parameters in the first track and associate the extracted parameters with the first layer using a sample group;
storing the extracted parameters in the first track and associated them with the extracted remaining layers; and
storing the extracted parameters in the sample group.

43. The method of claim 42, wherein a sample entry comprises the first configuration box and a second configuration box comprises the remaining layers.

44. The method of claim 43 further comprising: creating the file comprising:
network abstraction layer units of a base layer with layer identity equal to 0 and NAL units of the additional layers with layer identity not equal to 0 in samples of the track; or
sample auxiliary information with auxiliary information type comprising a sample entry type.

45. The method of claim 44 further comprising: defining a restricted scheme comprising a scheme type parameter in a scheme type box set equal to a 4 character code lsai.

46. The method of claim 45, wherein when the scheme type is equal to lsai it indicates that a track comprises a multilayer bitstream and the sample entry of the track comprises the configuration box mapping to a network abstraction layer (NAL) units with a layer identity equal to 0 and a configuration box mapping to NAL units with layer identity not equal to 0.

47. The method of claim 45, when the scheme type is equal to lsai, the track is restricted track with restricted scheme information box and encrypted with encrypted scheme information box.

48. The method of claim 47, wherein the when the track is encrypted together with the restricted scheme, the second configuration box is moved inside the scheme information box, wherein the scheme information box resides under the restricted scheme information box or encrypted scheme information box.

49. The method of claim 48 further comprising: defining a secondary layer box or a multilayer box comprised in a sample entry of the track, wherein the secondary layer box or multilayer box indicates that the track comprises the multilayer bitstream.

50. The method of claim 49 further comprising: encapsulating the second configuration box inside the secondary layer box or the multilayer box comprised in the sample entry of the track.

51. The method of any of the claim 49 or 50, wherein the secondary layer box or the multilayer box comprise following parameters: auxiliary information type and auxiliary information type parameter.

52. The method of claim 51, wherein when multiple streams are present in the track the auxiliary information type and auxiliary information type parameter map to a specific track.

53. The method of claim 43, wherein when the sample entry of the track is a single layer sample entry and the sample entry comprises the first configuration box and the second configuration box, a profile, tier and level (PTL) structure values in a video parameter set (VPS) and a sequence parameter set (SPS) belonging to a base layer is oversaturated.

54. The method of claim 42, wherein NAL units related to the remaining layers are dropped by a file reader compatible with the single layer sample entry, during reconstruction of the bitstream from the track.

55. The method of claim 42 further comprising: defining a high efficiency video codec sequence parameter set (HEVCSPS) sample group, wherein a sample group description entry of HVECSPS sample group comprises an HEVCSPS NAL unit with a profile, tier and level (PTL) value matched with base layer NAL units.

56. The method of claim 55, wherein when a sample is mapped to the HEVCSPS sample group it indicates that the HEVCSPS NAL unit comprised within the sample group description entry needs to be inserted into a reconstructed AU, when a target PTL format corresponds to a PTL format indicated by the grouping type parameter field in sample to group boxes for the parameter set sample group.

57. The method of claim 55, wherein when HSPS is comprised in a high efficiency video codec track, a sample is marked as belonging to the HSPS sample group when any of the following is true:
the sample of a high efficiency video codec (HEVC) track comprises a sequence parameter set (SPS) NAL unit; or
the sample references a different sample entry than a previous sample in decoding order, and the sample entry comprises the SPS NAL unit.

58. The method of any of the claims 55 to 57, wherein instances of the sample to a group box for the HEVCSPS sample group comprises a grouping type parameter.

59. The method of claim 58, wherein the grouping type parameter field for the HEVC SPS parameter set sample group comprises:
a HEVC PTL for a base layer; and
a PTL that specifies a PTL format of a target reconstructed bitstream for which a HEVCSPS NAL unit is to be inserted.

60. The method of claim 42 further comprising: defining the high efficiency video codec video parameter set (HEVCVPS) sample group, wherein, the sample group description entry of the HEVCVPS sample group comprises an HEVCVPS NAL unit with a profile, tier and level (PTL) value matched with base layer NAL units.

61. The method of claim 60, wherein when a sample mapped to a HEVCVPS sample group it indicates that the HEVCVPS NAL unit comprised within the sample group description entry needs to be inserted into the reconstructed AU when a target PTL format corresponds to the PTL format indicated by the grouping type parameter field in the sample to group box for the HEVCVPS sample group.

62. The method of claim 61, wherein when a sample group of type HEVCVPS sample group is comprised in a high efficiency video codec (HEVC) track, a sample is marked as belonging to the HEVCVPS sample group when any of following is true:
sample of a HEVC track comprises an video parameter sequence NAL unit; or
sample references a different sample entry than a previous sample in decoding order and the sample entry comprise the VPS NAL unit.

63. The method of any of claim 59 or 60, wherein instances of a sample to group box for the HEVCVPS sample group includes grouping type parameter.

64. The method of claim 63, wherein the grouping type parameter field specified for the HEVCVPS sample group comprises:
a HEVC PTL; and
a PTL for base layer that specifies a PTL format of a target reconstructed bitstream for which a HEVCVPS NAL unit is to be inserted.

65. The method of claim 42 further comprising: defining a high efficiency video codec video parameter set and sequence parameter set HEVCVPSSPS sample group, wherein a sample group description entry of HEVCVPSSPS parameter set sample group comprises a high efficiency video (HEVC) video parameter set (VPS) network abstract layer (NAL) unit and the HEVC sequence parameter set (SPS) NAL unit with a profile, tier and level (PTL) value matched with base layer NAL units.

66. The method of claim 65, wherein when a sample mapped to a HEVCVPSSPS parameter set sample group it indicates that the HEVC VPS NAL unit and the HEVC SPS NAL unit comprised within a sample group description entry needs to be inserted into a reconstructed AU when a target PTL format corresponds to a PTL format indicated by the grouping type parameter field in the sample to group boxes for the parameter set sample group.

67. The method of any of the claim 65 or 66, wherein when the HEVCVPSSPS sample group is present in a HEVC track, a sample is marked as belonging to the HEVCVPSSPS parameter set sample group when any of the following is true:
a sample of a HEVC track comprises an VPS NAL unit and/or the SPS NAL unit; or
sample references a different sample entry than a previous sample in decoding order and the sample entry comprises an VPS NAL unit and/or SPS NAL unit.

68. The method of any of the claims 65 to 67, wherein instances a sample to group box for the HEVCVPSSPS parameter set sample group comprises grouping type parameter.

69. The method of claim 68, wherein the grouping type parameter field specified for the HEVCVPSSPS parameter set sample group comprises:
an HEVC PTL; or
a PTL for based that species the PTL format of a target reconstructed bitstream for which a HEVC VPS NAL unit and/or the HEVC SPS NAL unit is to be inserted.

70. The method of any of claims 65 to 67 further comprising defining a HEVC PTL sample group, and wherein, a HEVC PTL sample group is used in the HEVC track with HEVC LHVC sample entry.

71. The method of claim 70, wherein each sample group description entry indicates the SPS in which the PTL information is to be rewritten when the file reader drops the NAL units for the non-base layers.

72. The method of the claim 71, wherein each sample group description entry comprises a rewriting information structure comprising:
a length of profile, tier and level (PTL) syntax elements;
a bit position of PTL syntax elements in a raw byte sequence payload (RBSP);
a flag indicating whether to start code emulation prevention bytes are present before or within PTL; and
an SPS parameter set identifier of a parameter set comprising the PTL to be rewritten.

73. The method of claim 70, wherein each sample group description entry of the HEVC PTL sample group indicates a VPS in which the PTL information is to be rewritten when the file reader drops the NAL units for the non-base layers.

74. The method of the claim 73, wherein each sample group description entry comprises a HEVC PTL rewriting information structure comprising:
the length of PTL syntax elements;
the bit position of PTL syntax elements in the containing RBSP;
a flag indicating whether start code emulation prevention bytes are present before or within PTL; and/or
the VPS parameter set identifier of the parameter set containing the PTL to be rewritten.

75. The method of claim 70, wherein each sample group description entry of the HEVC PTL sample group indicates the VPS and/or SPS in which the PTL information is to be rewritten when the file reader drops the NAL units for the non-base layers.

76. The method of claim 75, wherein, in response to base layer selection, each sample group description entry comprises a HEVC PTL rewriting information structure comprising one or more of the following:
a length of PTL syntax elements;
the bit position of PTL syntax elements in the containing RBSP;
a flag indicating whether start code emulation prevention bytes are present before or within PTL;
the VPS parameter set identifier of the parameter set containing the PTL to be rewritten; and/or
the SPS parameter set identifier of the parameter set containing the PTL to be rewritten.

77. The method of claim 50, wherein a SAI corresponding a layer is stored in mdat consecutively with other SAIs of same layer and as consecutive chunks which come after the base layer chunks.

78. The method of claim 50, wherein chunks relating to different layers are grouped together and stored in segments or track fragments.

79. A method comprising:
receiving a file;
determining a single layer and a multi-layer data from the file; and
extracting data and related parameters sets of the single layer and the multi-layer.

80. The method of claim 79, wherein, when a file reader is compatible with the single layer, the method further comprises: dropping network abstraction layer (NAL) units related to layers other than the single layer while reconstructing a bitstream.

81. A method comprising:
receiving a video bitstream represented by two or more layers and comprising parameter sets describing a decoder requirements;
extracting a first layer from the two or more layers from the video bitstream to generate an extracted first layer;
storing the extracted first layer in a first track in a file;
extracting remaining layers of the two or more layers from the video bitstream to generate extracted remaining layers;
storing the extracted remaining layers in the first track along the first layer as an sample auxiliary information associated with the first track;
extracting parameters set from the video bitstream to generate extracted parameters of first layer;
re-writing and storing the extracted parameters of first layer in the first track;
associating the extracted parameters with the first layer using a first configuration box;
storing the first configuration box in the sample entry of the first track;
re-writing and storing the extracted parameters of remaining layers in the first track associating the extracted parameters with the remaining layer using a second configuration box;
creating a restricted scheme using SchemeTypeBox with the scheme_type parameter in the SchemeTypeBox indicating the presence of remaining layers in the sample auxiliary information of the first track;
creating a new SecondaryLayerSAIBox or MultiLayerSAIBox present in the SampleEntry of the first track; and
storing the second configuration box in the SecondaryLayerSAIBox or MultiLayerSAIBox.

82. A method comprising:
receiving a file;
determining a presence for a first layer and a remaining layers data from the file;
extracting data and related parameters sets of the first layer from a first configuration box;
extracting data and related parameters sets of the remaining layers from a second configuration box;
wherein a restricted scheme using SchemeTypeBox is created with the scheme_type parameter in the SchemeTypeBox for indicating the presence of remaining layers; and
wherein a new SecondaryLayerSAIBox or MultiLayerSAIBox present in the SampleEntry stores the second configuration box in the SecondaryLayerSAIBox or MultiLayerSAIBox.

83. An apparatus comprising means for performing methods as claimed in any of the claims 42 to 78, 79 to 80, 81, or 82.

84. A computer readable medium comprising program instructions that, when executed by an apparatus, cause the apparatus to perform method as claimed in any of the claims 42 to 78, 79 to 80, 81, or 82.

85. A computer readable medium of example 84, wherein the computer readable medium comprises a non-transitory computer readable medium.
